(19) United States
(12) Patent Application Publication
(10) Pub. No.: US 2016/0180386 A1
(43) Pub. Date: Jun. 23, 2016

(54) SYSTEM AND METHOD FOR CLOUD BASED PAYMENT INTELLIGENCE

(71) Applicant: Francis Konig, Beverly Hills, CA (US)

(72) Inventor: Francis Konig, Beverly Hills, CA (US)

(21) Appl. No.: 15/055,172

(22) Filed: Feb. 26, 2016

Related U.S. Application Data
(63) Continuation-in-part of application No. 14/192,836, filed on Feb. 27, 2014.
(60) Provisional application No. 62/120,960, filed on Feb. 26, 2015.
(60) Provisional application No. 61/770,217, filed on Feb. 27, 2013.
(60) Provisional application No. 61/944,972, filed on Feb. 26, 2014.

(51) Int. Cl. G06Q 30/02; H04L 29/08; G06Q 50/00

(52) U.S. Cl. CPC G06Q 30/0255; G06Q 50/01; H04L 67/306

(57) ABSTRACT

A system and/or method is provided of managing a plurality of devices to establish a user-to-user and user-to-merchant interrelated on-line network. A plurality of data communication connections are established simultaneously over respective channels with computing devices respectively operated by user members and merchant members. An interrelated network of user members and merchant members is established as a function of the information received via the data communication connections from the user members and the merchant members, including by assessing a respective value of each of the user members to each of at least one of the respective merchant members by continually processing network activity information. A numerical value representing respective assessments of the user members in the established interrelated network is generated, and a reward and/or advertisement offered is distributed to each of the computing devices, as a function of the respective generated numerical value.

### CROSS-REFERENCE TO RELATED PATENT APPLICATIONS

This application is based on and claims priority to U.S. Provisional Patent Application 62/120,960, filed Feb. 26, 2015 and entitled, “SYSTEM AND METHOD FOR CLOUD BASED PAYMENT INTELLIGENCE,” and; further, this application is a continuation-in-part of U.S. patent application Ser. No. 14/192,836, filed Feb. 27, 2014 and entitled, “SYSTEM AND METHOD FOR CLOUD BASED PAYMENT INTELLIGENCE,” which claims the benefit of U.S. provisional patent application Ser. No. 61/770,217, filed on Feb. 27, 2013 and entitled, “SYSTEM AND METHOD FOR CLOUD BASED PAYMENT INTELLIGENCE,” and further to U.S. provisional patent application Ser. No. 61/944,972 filed on Feb. 26, 2014 and entitled, “SYSTEM AND METHOD FOR CLOUD BASED PAYMENT INTELLIGENCE,” the entire contents of all of which are incorporated by reference as if set forth herein in their respective entireties herein.

### FIELD

The present application relates, generally, to networks and, more particularly, to targeting communications.

### BACKGROUND

As the world is getting more connected, the actions of an individual or business are normally noticed and replicated or attempted by peers and observers. This ability to influence others' spending, activity, opinion and preferences is highly desirable to businesses as it leads to increased sales due to introduction of new customers and/or customer loyalty accruing from alignment of preferences and interests. The influence is normally measured in spending capacity as well as ability to reach a larger than normal number of people willing to listen, read or watch an individual or business' communication or behavior.

Understanding and accurately estimating the activity and ability of a customer (individual or another business) has been a challenge for a number of businesses. This gets harder for small businesses without market research departments or large advertising budgets to spread out and reach a bigger part of their target market, not mentioning expensive trial and error approaches. Making matters worse, access to current and potential consumers' confidential information is heavily shunned because of the infringement on privacy and illegality of some access methods. The color or type of a person's credit card or, where possible, obtaining a person's cash balance, credit balance, or Fair Isaac Corporation (FICO) score, which may be available, does not provide businesses with enough information to understand how likely that person is to purchase his/her products or services and/or their spending potential as it pertains to certain categories of products or services. Other types of information, such as a measurement of the person's historical spending at a single merchant usually does not provide enough data-points to understand a customer's spending preferences outside that merchant's business, or his/her influence on friends' expenditure habits. Attempts by previous inventions at predicting a customer's spending ability by assigning a single non-evolving score based on a user's transactions leaves a lot of room for inaccuracies.

Accordingly, there is not a method and apparatus for accurately and continually estimating a consumer's activity and ability—beyond spending, assign a score to it and update it based on his/her activity and other related non-activity information, while presenting it in a simple, easy to understand and usable format to interested and approved parties without compromising the owner's sensitive personal information.

### SUMMARY

In one or more implementations, a system and/or method is provided of managing a plurality of devices to establish a user-to-user and user-to-merchant interrelated on-line network. A plurality of data communication connections are established simultaneously over respective channels with computing devices respectively operated by user members for reception of user member information representing user profiles of user members, connections between user members, locations of user members, and/or financial transactions of user members. Further, a plurality of data communication connections are established simultaneously over respective channels with computing devices respectively operated by merchant members for reception of merchant information representing goods/services, promotions, and/or store locations. An interrelated network of user members and merchant members is established as a function of the information received via the data communication connections from the user members and the merchant members, including by assessing a respective value of each of the user members to each of at least one of the respective merchant members by continually processing network activity information representing user member spending, connections among user members, and/or respective wealth of user members. A numerical value representing respective assessments of the user members in the established interrelated network is generated, and a reward and/or advertisement offered by each of the respective merchant members is distributed to each of the computing devices respectively operated by the plurality of user members, as a function of the respective generated numerical value.

Other features and advantages of the present application will become apparent from the following description of the invention that refers to the accompanying drawings.

### BRIEF DESCRIPTION OF THE DRAWINGS

Further aspects of the present disclosure will be more readily appreciated upon review of the detailed description of its various embodiments, described below, when taken in conjunction with the accompanying drawings, of which:

FIG. 1 is a block diagram showing an overview for generating a user's score the first time;

FIG. 2 is a diagram showing the process of continuous adjustment of a user's score based on affecting factors;

FIG. 3 shows an example of user categorization according to respective scores;

FIG. 4 is a diagram illustrating the referral network relationship between users;

FIG. 5 is an illustration of an example of an approach to rewarding users in the network (using signup commissions and cash back rewards);

FIG. 6 is a diagram showing an example of a reward scheme for signup commissions;

FIG. 7 is an overview diagram for generating a System Score;

FIG. 8 is a schematic diagram of the system—which embodies the computerized part of the network;

FIG. 9 is a diagram is provided illustrating an example hardware arrangement in accordance with an example implementation of the present application;

FIG. 10 illustrates functional elements of an example information processor and/or user workstation, in accordance with an example implementation;

FIG. 11 is a flowchart illustrating steps associated with an example implementation of the present application;

FIG. 12 illustrates an example data entry display screen identifying offers and a Store Score for a user in connection with a respective merchant, in accordance with an example implementation of the present application;

FIG. 13 is an example data entry display screen identifying an interactive map and identifying locations and directions to respective merchant stores, in accordance with an example implementation of the present application;

FIG. 14 illustrates an example data entry display screen identifying information associated with a respective user's money and activity, in accordance with an example implementation of the present application;

FIG. 15 illustrates an example data entry display screen that identifies an established network of user members in connection with a respective user, in accordance with an example implementation of the present application;

FIG. 16 is an example merchant data entry display screen that identifies a plurality of customers for a respective merchant, in accordance with an example implementation of the present application;

FIG. 17 is an example merchant data entry display screen that identifies promotions including cash back rewards associated with respective scores; and

FIG. 18 is an example merchant data entry display screen, which illustrates a selection of an option to edit a cash back percentage.

### DETAILED DESCRIPTION

Specific configurations and arrangements are provided herein for example and illustrative purposes. Other configurations and arrangements can be used without departing from the spirit and scope of the present invention. Also, it will be apparent to a person skilled in pertinent art that this invention can also be employed in a variety of other applications and industries.

As used herein, the terms “entity,” “consumer,” “user,” “user member” and/or their plural form refer, generally, to an individual, software, system, or business that is part of and uniquely recognized as an actor in a social/economic and/or data communication network, such as shown and described herein. The entity is capable of accessing, using, being affected by or benefiting from the system that the present application entails.

In addition, the terms “business,” “merchant,” “merchant member,” or “store” may be used interchangeably and refer, generally to any entity, person, distributor system, software and/or hardware that can be a provider, broker, advertiser, and/or any other entity in a distribution chain of goods or services. For example a merchant may be a car dealer, a travel agency, a healthcare service provider, an online merchant or the like.

Also as used herein, the term, “score,” as in “System Score” (also, in one or more implementations, referred to herein as a “Clout Score”), “Store Score” or “Merchant Score” is used to refer, generally, to a value (e.g., a number) to represent at least one of performance and/or rank of an entity in the system. A score may be influenced, for example, as a function of activity and/or ability (such as ability to influence other entities) of an entity in the network of other entities supported by the system described herein.

Further, the term “referral” refers, generally, to an invitee of an active user on the Clout network who accepts an invitation from the user and joins the network.

Further, the terms “system” and “platform” may also be used interchangeably and refer, generally, to a collection of the system, one or more of its components, actors and administrators that the present application embodies. In one or more particular contexts, a “system” can also refer to an entity.

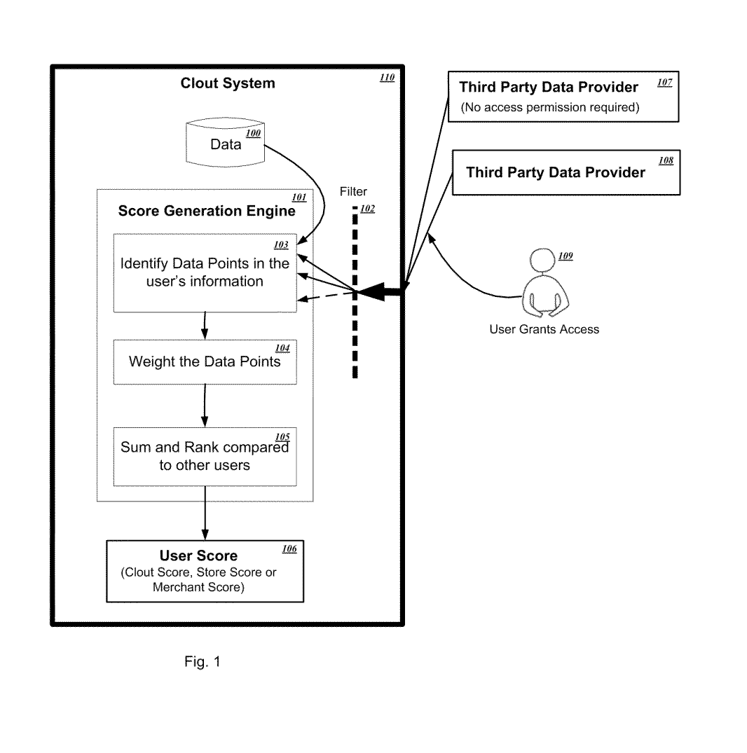

In accordance with the present application, a score can be generated by collecting, filtering, categorizing, weighting, tracking, and measuring data about an entity and that can be received from sources authorized or provided by a user as well as one or more public and/or private sources. Referring to the example system shown in FIG. 1, information can be collected in various ways. Example ways that information can be collected include, but are not limited to:

1) Purchasing data from third party data providers. In this example, data can originate from a database, or can be obtained via data access through a pre-established process, such as a third-party API query, cron job or manual data transmission. Such data may include transaction information, user location or additional information about a user, among others.

2) The user providing access to his/her data domiciled at a third-party system. User consent and/or user log-in at the third party system can be required to confirm identity. Such data can include the user's personal information, contacts, bank accounts, or financial transactions.

3) Scraping data from public data sources. In one or more embodiments of the present application, public data sources can include online public libraries, government census data, and telephone directories. Examples of data obtained from these sources can include business information and contacts, general population data about a geographical area, and trends in consumer preferences.

4) Data submitted by the user or automatically collected by a system from the user. In this example, data can include check-in location information, survey submissions, system activity tracking information, and third party computer system data submitted about a user's activities, such as from a point of sale.

Data can be filtered to remove information not relevant to the scoring process of the systems and methods disclosed herein, and therefore would be an extra processing burden. Removed information can include non-relevant details of purchased items at a store, color preferences, an individual's healthcare information, an individual's phone numbers, an individual's email addresses, an individual's name, an individual's address, and the user's family information.

Filtered data can be passed to one or more categorization processes that organize data such that operations on the data can be accelerated and simplified. For example, businesses can be sorted by Standard Industrial Classification (SIC) codes such that related businesses can be compared to their peers. In one or more implementations in accordance with the present application, individual representing individual users can be sorted by location such that the system can easily and quickly provide appropriate user information or compare the user with others in the same area to generate a reasonable score.

Tracking a user's activity can be achieved through the system's data collection capabilities and/or participation of third-party data providers. For example, user's actions (e.g., logging in by submitting user name and password, linking credit card(s) to the system, opting-in to receive promotions and/or advertisements, answering surveys, or inviting the user's contacts) can be recorded and performance evaluated and stored in the tracking database for future reference. With regard to third-party providers, one or more processors configured by executing code can track and report off-line relevant activities to the system such that the user can receive extra consideration during generation of scores. Such off-line activities can include off-line cash purchases, participation in a merchant member's promotion, or fundraising drives, and promoting the system to friends outside of the network.

In accordance with the present application, a data point can be measured by first determining the data point's type. For example, the type can be a Boolean value (e.g., has the user connected a social network? YES/NO), a numeric value (e.g., how many friends did the user refer last month? 893 OR how much did the user earn in cash back in the last 180 days? $1,285.50), a text value (e.g., what is the user's address? 123 Example Street, New York, N.Y. 14032), a list of numbers (e.g., what are the last five purchase amounts by the user? $23.80, $10.00, $59.50, $3.50, $9.99), or an image (e.g., does the user have a current photo? https://www.clout.com/images/C123902123.jpg). Based on the type, one or more processors executing code can determine an expected value for the data point. The data point value can then be computed or retrieved by the system processes, and prepared for use by the user/system that requests it.

To join a network established in accordance with the teachings herein, an entity or its representative provides identifying information and may be required to provide proof of validity where applicable. Proof of validity can include but is not limited to the entity's name, address, contact information, and referring entity.

In addition, credentials to third party sources of information can be included to fill in information gaps in an entity's profile, such as to connect financial accounts with one or more processors. Credentials can include a third party source's user name and password as well as other personally identifying information to prove his/her identity. Unless otherwise indicated, credentials to third party sources are usually not stored or used by the system for other purposes. Examples of data obtained from third party sources can include user contacts, transaction history, device usage, service or product preferences, and identifying or classification information.

Referring back to the example system shown in FIG. 1, data collected about a user is organized and filtered for information 102 relevant to the system. Examples of relevant data-points include whether a user completed his/her profile, adding other users to the referral network established by the present application, tracking of bank spending history, bank account activity, store purchases, and whether the user redeemed and/or responded to promos and/or advertisements.

In one or more implementations, one or more processors can weight filtered information, for example, based on a level of importance to the network, the other users, and the user's profile 104. In the data collected about a user, data points (parameters) are identified, which can be used by a processor executing code to compare performance of a user versus other users in the network. Example performance parameters can include amount, quality, age, accuracy, or ease of obtaining the data. In one or more implementations, a processor weighs data points to increase fairness in network scores, such as without a consideration of one or more of the user's attributes, such as age, gender, race, national origin, or name.

In one or more implementations, quantified information, such as rank and/or scores can be used to determine the price of delivering advertising and/or promotions to an entity or entities. Moreover, quantified information, rank, and/or score can be used to determine the price of products or services offered to and/or consumed by an entity. Still further, quantified information, rank, and/or score can be used to determine if, when, how, and/or how much certain terms and/or conditions and/or price and/or compensation should be modified by an entity and/or for an entity.

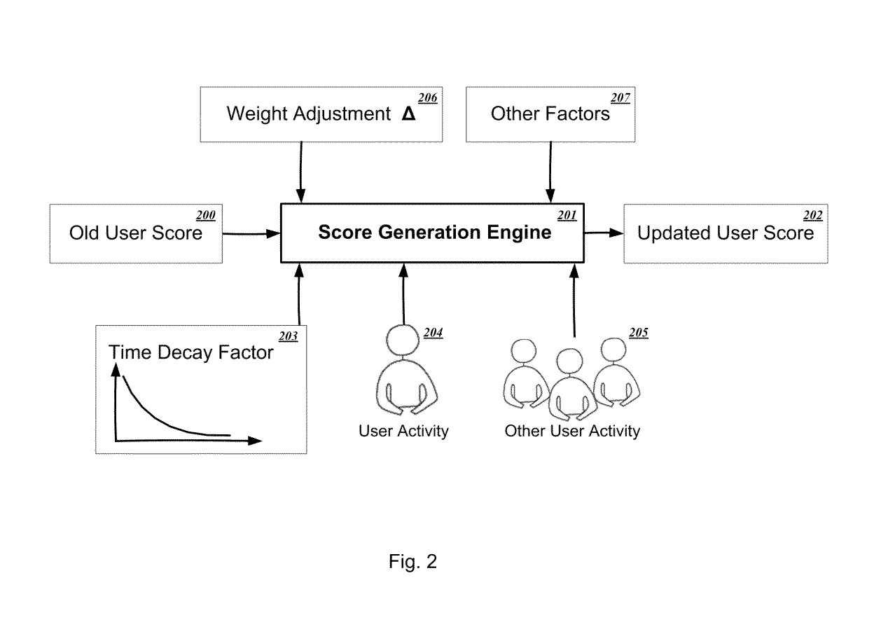

A processor executing code can assign a score to a data point for a given user by designating a weight to the data point based on his/her rank among other users under consideration. For example, a minimum and maximum score can be attached to each data point to normalize the results and give a fair consideration to all members. Referring to the example in FIG. 2, the total score 202 can be obtained by summing adjusted weights and ranking them in relation to other users. In one or more implementations of the present application, a score generation engine 201 can be used to rank and compare one user to other users in the system (with the scoring based on factors that are important for the system). The score can be used to rank and compare one user to the other users as those users relate to an entity in the system (with the scoring based on factors that are important for the entity). Using this technique, each user can have an overall system score, and separate scores for each entity in the system which is unique to that entity. In an instance when at least one of the entities is a merchant, the score is referred to as a “Store Score.” A user's Store Score can vary substantially from one entity to another, for example, depending on a user's activity 204 compared to activity of other users 205 for each of the data-points of interest, other factors 207 being measured for each such entity, and the weighting of such data-points 206, and taking into account the time decay factor 203.

A user's score can rise or fall based on that user's activity 204. If the user is inactive for longer than a data point's period of relevance, the data point can start to decay 203. In other words, a user's score that was previously high can fall if there is no activity from the user in relation to the system. For example, if a previously, highly-active user (with a high score) loses his or her financial resources and cannot spend as before, he or she may not retain the high score based on his/her previous status. A user's Clout Score and respective Store Score adjust accordingly to reflect his/her current status such that businesses are not misinformed about the user's spending ability. In another example in accordance with the present application, if a business that used to sign up a number of its clients to the network suddenly stops or reduces its rate of sign up by changing or modifying its business policies, a user's Merchant Score adjusts accordingly. This ensures that privileges and rewards are also updated to reflect a new policy.

Additionally, in one or more embodiments of the present application, if a user participates in or originates an activity that violates network policies, the user can be blocked from future access to the system or otherwise punished by lowering his/her score by a predetermined or weighted amount. A note can also be tagged to his/her record such that other members of the network that are interested in dealing with them are aware of the fact beforehand. Such activities can include cheating or defrauding the system or an entity in the system, breaches of system terms and conditions, un-authorized access to any network data or other non-public sections, cyber-bullying other users on the system, sending unauthorized messages or spam, defacing other user's profiles—even if the other user provided them access, or any other activities that make a user a nuisance to other users, the network administrators or the system itself.

Furthermore, a score can be modified due to an update to the weight of a given data point 206. This weight can be adjusted by an authorized user such as the network administrator, a merchant store manager (for a Store Score) or the system itself (based on a statistical analysis). This modification is continuous to ensure a more accurate computation of a user's influence. For example if, after a statistical analysis, it is observed that when comparing users who otherwise spend the same amount of money on average and whose spending is concentrated in one particular sector (e.g., travel and entertainment) verses another sector (e.g., automobiles), they are more likely to spend a larger portion of their disposable income, or are more likely to respond to promotions, or have a higher influence over their counterparts, then the weighted value of the data point for travel and entertainment spending may be increased to better reflect the value of the users. The Store Score for the respective users who are affected by this modification may increase, for example, based on weighting of these factors with respect to merchant members who are classified in the applicable category.

In one or more implementations, assessing a respective value of a user member includes managing information associated with spending activity at a merchant member's store, at a merchant member's affiliated store, at a competitor's store and/or in a particular product category.

Activity of the other users in the network can also affect a user's score. A reduction or increase in their activity in relation to the user's activity can raise or lower the user's score, respectively. This is because, in one or more implementations, the score may involve a rank aspect and those who are more active (e.g., respond to more promotions, spend more, have a higher account balance, or refer more of their friends to the network) receive an increase in their scores. In contrast, the score of a dormant user can start to fall when adjusted for rank of the activity results (e.g., dormant user responds to fewer promotions, spends less, has a lower account balance, or refers fewer friends to join the system).

Also, unless specified otherwise, most data points awarded have an expiry date or decay factor 203. To maintain the points awarded, the user continues participating in an activity related to the data point. For example, if 50 points are awarded for a check-in at a business during the last 7 days and the user does not check-in by the 7th day, their previous 50 points for this data point start to decay on the 8th day.

Other factors 207 can also affect the user's score. These factors can be adjusted (added or removed) by the network administrators to ensure fairness of the scores generated. These factors can include, but are not limited to the following: the user's cash balance, the user's credit balance, location, credit rating, answering a survey, complaints filed by other users, and user feedback ratings. These factors are considered based on statistical analysis of network data, user feedback, or the network policies.

Additionally, in accordance with the present application, one or more processors configured by executing code can assign the score to an entity denoting a physical location. The location entity can establish one or more data-points that represents an accumulation and/or flow of users that spend at a network-affiliated merchant located at the given address. The value of the location entity rises as user traffic and spending increases, thereby creating more demand for the property or real estate. Examples include a home goods store located in a shopping center or a fast food restaurant located on a city street.

The collection, organization, and calculation of spending activity at a location can provide a method to measure and rank the value of a property using or in association with a score. The property score can be comprised of spending activity of one or more users associated with the property, the user(s)′ referral network, and/or financial activity of the merchant at the location. This results in insight into the business ecosystem, hence more accurate scores and appropriate rewards.

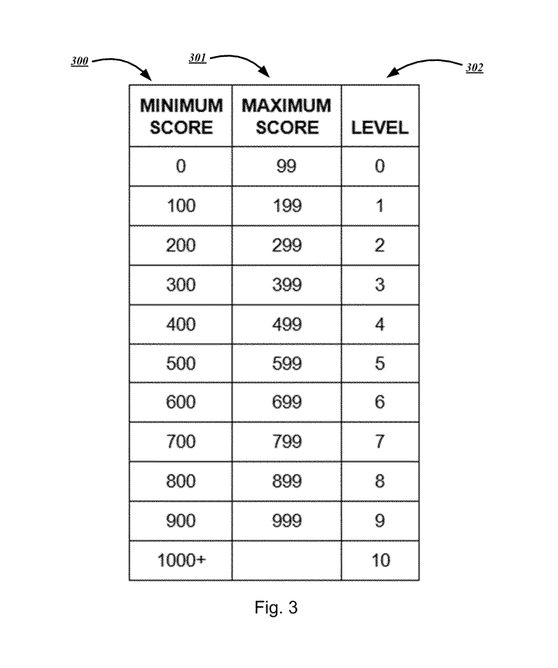

In one or more implementations, a reward provided to a user in the network is determined using a score associated with the user. Moreover, the amount of reward, type of reward or the way the reward is administered can be changed based on type of user, source of reward, location of the user, other users related to the user, time of reward, or the user's score. To ease reward distribution, users can be categorized into levels based on scores. FIG. 3 provides an example of a score level categorization. In one or more embodiments of the present application, levels can be categorized by name (e.g., silver, gold, VIP, etc.). Referring to the example shown in FIG. 3, each respective level 302 has a minimum and maximum point score. The minimum point score can be the fewest number of points a user has to accumulate before they qualify for that level 300.

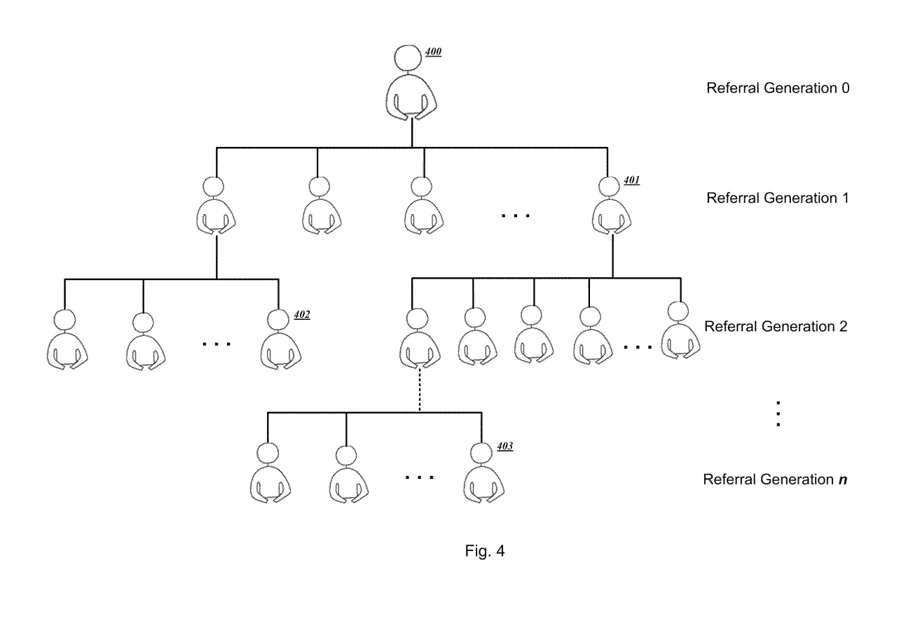

First, the system monitors or otherwise determines user referrals based on relationships within the network. With reference to the example in FIG. 4, other users can be related to a user 400 through a direct referral relationship (such as for a user who has been invited to join the data communication network of the present application) 401. Alternatively, users can be related in accordance with an indirect referral relationship, such as a user who was directly invited by a user to join the network (e.g., a “generation 1 user”) invites one or more other users to join the data communication network of the present application (e.g., a “generation 2 user”) 402, 403. Any users beyond referral generation 1 are considered to have an indirect-referral relationship with a user.

The present application is now further described with reference to a non-exhaustive list of example implementations of rewarding users in an established network.

A user can be rewarded or can become eligible for a reward by inviting a friend/contact (invitee) to join the network and his/her invitee agrees to the request. As used herein, such an invitee is considered the referral; the user who invited the referral is considered the direct referrer. In addition, if the referral also signs up his/her friend/contact, then the referral becomes a direct referrer of the new referral (also called the “child” of the member who referred him/her), and the initial inviting user who invited this direct referrer becomes an indirect referrer (also referred to as the “parent” of the member he referred). Indirect referrers can also be rewarded for the activities, influence, and spending of indirect referrals. The rewards can be set to stop at n generations deep of the referral network (where n may be any number, e.g., 4) as detailed in the example in FIG. 4. Rewards can be in monetary or non-monetary form.

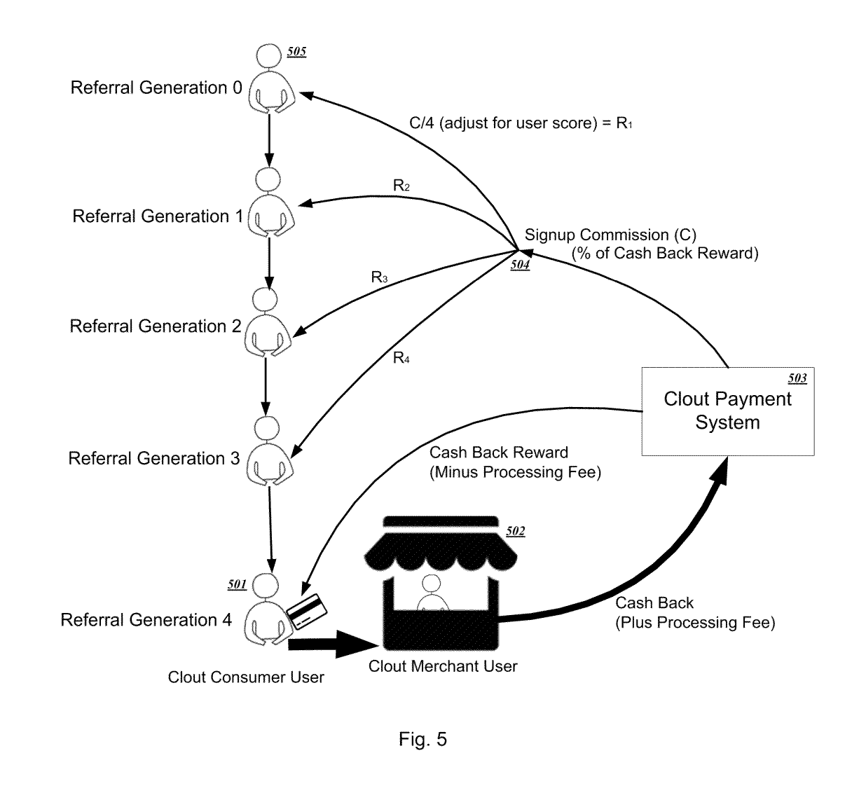

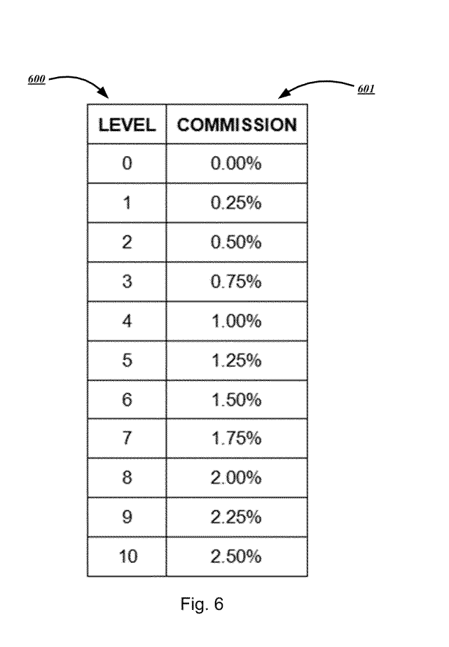

For example, with reference to FIG. 5, when a direct referral or indirect referral 501 makes a purchase at a network-affiliated merchant 502, the direct referrer and n generations of parents of the direct referrer may be entitled to receive a commission. One example of a reward that may occur in the system is a cash back reward. This reward can be triggered when a referral makes a purchase at a network-affiliated merchant offering a cash back reward to system users who make a qualified purchase that matches a criteria set by the merchant. Upon distribution of the cash back reward to the user, the referrers may be entitled to collect a percentage of the cash back distribution (or other form of reward). The payout C 504 can be tied to and commensurate with each user's system score. For example, using a reward distribution scheme as shown in the example in FIG. 6, a referrer with a score of 650 points (level 6) would receive 1.50% of the cash back that the system collects from the merchant with respect to the transaction by the referral.

If the rewards relationship is set to 4 generations deep from the buying user, then the direct referrer, his parent, the grandparent, and the great grandparent would each be eligible to earn a reward when such referral user makes a purchase. For example, if the cash back reward from the merchant is 10% and the referral purchase is $100, then the cash back reward amount would equal $10. Further, if each of the 4 eligible referrers have scores of 320, 430, 670, and 980, then based on the example shown in FIG. 6, the referrers will be entitled to commissions equal to 0.75%, 1%, 1.50%, and 2.25% of the cash back reward, respectively, and the payout to each referrer would equal to $0.075, $0.10, $0.15, and $0.225, respectively. The reward component of the system is designed to be flexible such that any monetary or non-monetary reward (such as a modification of any term and/or condition) can be substituted as in the example above, with the ability to increase the value (or perceived value) of such reward as the referrer's score increases, and such that a reward can be issued for any measurable activity.

A user can receive direct cash back from a qualifying transaction if a merchant member is offering a cash back reward or cash back discount on the transaction and the user paid using a device or financial institution account recognized in the system and linked to his/her user account. The cash back can also be adjusted based on the user score with a higher score leading to a higher cash back reward. The cash back amount offered to users can be controlled and adjusted by the merchant member and can be set to increase or decrease in value based on the score level of the user with that merchant.

In one or more embodiments of the present application, merchant members can offer direct monetary or non-monetary rewards to qualifying consumer users for purchases or activities with their businesses. These can include free/bonus products or services, special sales, special experiences, VIP treatment/admittance, and special upgrades/perks. These offers can also be commensurate with the user score to attract users with a higher spending capability/influence. Moreover, system communication can be determined and generated that represents a product, a recommendation, an advertisement, a service, an event, a discount, a perk, a term, and/or condition.

For example, a promotion “free court-side ticket for Lakers vs. Nuggets on Dec. 15, 2014 for the first 10 purchases this Saturday” may be offered to members who are level 8 and above. In another example, a promotion such as “80% off Men's suits for the 3 users who have the highest in-store spending score and who check in publicly to our store this Sunday—Limit 3” may be offered to users of all levels for indirect marketing by a merchant member.

In one or more implementations, a Clout Score is a number assigned to an individual to reflect one or more of his/her overall profile, influence, spending, activity, loyalty and ability compared to all other individuals in the network. This score can be related to the following:

1) The attributes (data-points) of the individual that may be relevant in determining his/her online and offline influence, for example: whether the user's social network account is connected; whether the user's email is verified; whether the user's mobile phone is verified; whether the user has a valid profile photo; whether there is an active bank account linked to the user's account; the user's financial transactions, the value and makeup of a user's assets, the user's available cash balance; and the user's available credit balance.

2) The individual's activities and his relation to other users' activities on the system as well as off the system (where an activity can be tracked and is relevant to the system), for example: whether the user processed his/her first payment using the system; whether the user made a public check-in in the last 7 days; whether the user answered a survey in the system in the last 30 days; the number of direct referrals signed up versus other users in the last 180 days; and the amount the user spent through the system versus other users in the last 30 days.

3) The activities of other individual users in relation to the user on and off the system, for example: spending of the user's direct referrals versus spending of other member's direct referrals for the last 180 days; and lifetime spending of a user's network referrals versus lifetime spending of other member's network referrals (in this case “lifetime” refers to the period since the user joined the system or as far back as his/her available data to the system indicates, whichever is longer).

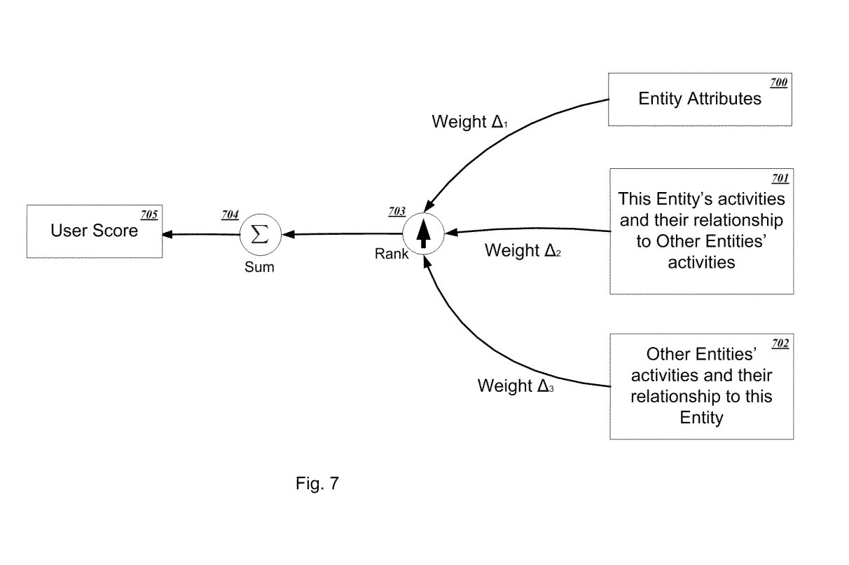

The data from the above criteria can be used to generate the user score as depicted in the example in FIG. 7. Weighting can be done by applying a minimum and maximum score to normalize the resulting value. The final value can be determined from preset scoring formulae which may be scalable or ON/OFF depending on the input data-point values and business rule requirements. Referring to the example in FIG. 7, a rank 703 can be applied to the weighted values in relation to other users before they are added up 704 for all data points under consideration to determine the user's score 705.

The Store Score is a number assigned to an individual to reflect his/her influence, spending activity, ability, and loyalty at a given store (merchant member premises or point of sale). This “store” can be a physical location or virtual presence, such as an e-commerce website. The user's influence at a store can be determined by considering the following.

1) The user's attributes and activities in the system which could affect a merchant member's interest in them, such as: available cash balance; average cash balance over a period (e.g., last 180 days), available credit balance; average credit balance over a period (e.g., last 180 days); credit rating; and presence of good behavior and/or misbehavior tags associated with the user in the system.

2) Previous activities with the merchant, for example: total in-store spending in the last 90 days versus total spending of other users at the same store; whether the user answered a store survey in previous 30 days; whether the user responded to a store advertisement in the previous 180 days; total promotions for the merchant by the user in the system; total responses by other users to the user's promotions of the store; and total check-ins at the merchant's store in the last 90 days.

3) Activities at the merchant's competitors or other businesses of interest to the merchant member, for example: total spending with direct competitors in the last 90 days; total spending at stores in merchant's industry category/related categories; total check-ins at the merchant's competitors; and total surveys taken at the merchant's competitors.

The approach to computing the Store Score and Merchant Score is similar to that of the Clout score depicted in FIG. 7 with the difference being the data-points under consideration for each user. Every user in the system can obtain a clout score for every merchant member registered with the system. The user Store Scores are important to merchant members in that they can easily gauge influence and capacity of their customers (other users) which translates to more targeted offerings and customer loyalty. The store owners can prepare their promotions to attract those with low scores at their store, reward loyalty or both.

Merchant members can also be assigned a score to determine their credibility and influence of in the system. This score can be an indicative number that other merchant members and even individual users may view when dealing with the merchant in question, or which can be used jointly or solely by the system. Merchant members with a high Merchant Score can receive non-public offerings and special consideration in the system due to their high influence. For example, a merchant with a high Merchant Score may receive a discount on paid advertisement in the system or a discount on processing fees.

To raise their Merchant Score, stores should watch 1) the store's attributes (profile data-points) on the system, such as: whether the merchant's bank account is verified; whether the merchant's profile is complete; whether the merchant accepts cash back discounts; and whether the merchant has network-related promotions running in its store; 2) the store's activities on the system, for example: whether the merchant processed its first payment in the system; whether the merchant ran a promotion in the system; whether the merchant has positive and/or negative behavioral flags (e.g., not honoring its offers, late payment of cash back, misuse of system messaging facilities, violation of network terms of use); and the number of referrals the merchant has attracted to the system versus other network-affiliated merchant members (in the store's industry category/zip code/region/whole Clout system); and 3) the user's activities at the store, such as: the amount users have spent at the store compared to other stores (in the store's industry category/zip code/region/whole system); the number of user check-ins that occurred at the store in the last 90 days in relation to other stores (in the store's industry category/zip code/region/whole system); and complaints from users about the store.

Merchant members may have access to non-identifying customer data to help them setup accounts and promotions for target audience upon joining the system. Fees may apply for one or more services accessed by merchant members in the system. Additionally, as described herein, a high Merchant Score can result in the merchant member receiving special offerings with features including but not limited to: discounted or free services, extra functions not available to other merchant members (such as drill down of target audience data and more views of reports), or relaxed protocols (such as non-verification of mobile phone push promotions).

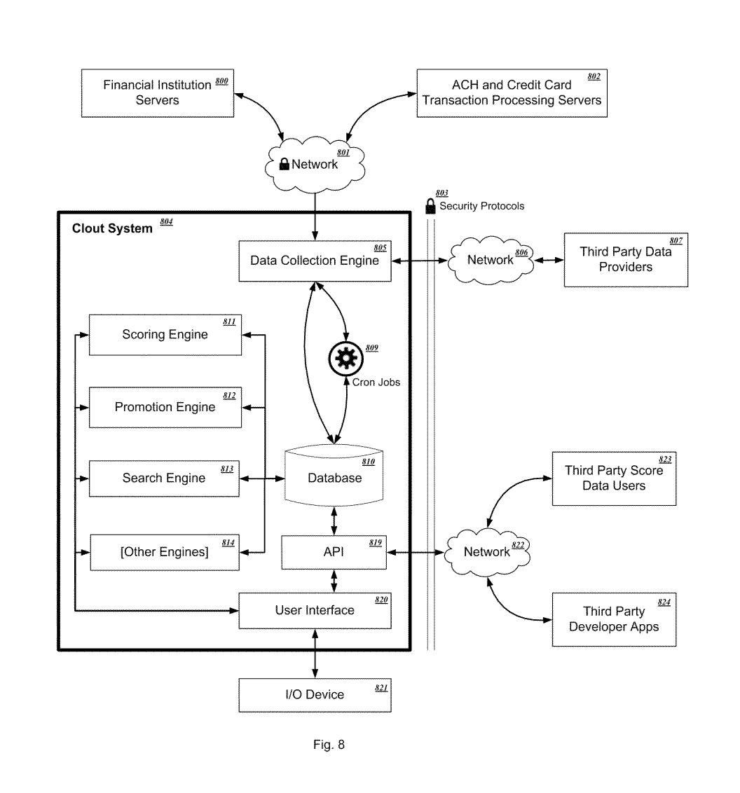

In one or more embodiments of the present application, and as shown in the example in FIG. 8, the Clout system 804 can be set up to include a computer network that may not be in one physical location—the “cloud”. Data used for the system can be obtained from the users or potential users, third-party data providers 807, and financial institutions 800. All data from non-secured sources passes the system security protocols and checks to be approved for use in the system. Some data may require the user to provide additional confirmation to be obtained from the third-party sources while other data may be scraped, purchased, or obtained by the system without the user's participation.

Data obtained from all sources can be collected, filtered, organized, formatted, and packaged for storage, search, processing, use, and display by a Data Collection engine 805, which works with the assistance of cron jobs 809 to perform its functions. For example, sources of data collection for all transactions with user activities on the system can be packaged for system processing that contain completed profiles, additions of other users to the referral network, tracking of bank spending histories, bank account activity, store purchases, redeemed promos, and other entities.

The clean and sorted data can be used by other engines of the system such as a search engine 813, promotion engine 812 and scoring engine 811, among others, to carry out user and system required tasks supporting the user interface features and system operations. In combination, the system parts create an intelligent “brain” that can track user relationships and is able to perform autonomous tasks in response to the discovered relationships. Such tasks can include updating a user's score, providing relevant information to a user (e.g., helpful tips), introducing/suggesting a relationship of a user to another user with whom there is a high degree of connection (e.g., a customer who always shops for similar items near a network-affiliated store with a high Store Score), and blocking or adding access rights to a user based on his/her record and activity in the system.

The user interface 820 is accessible using a variety of input/output (I/O) devices 821 including but not limited to laptops, desktops, mobile phones, tablets, wearable devices, store point of sale equipment, and specialized display equipment (e.g., auto infotainment systems and in-store marketing displays).

To extend the benefits of the user scores as well as other relevant data and statistics generated by the system, verified and approved third-party data users 823 and developer apps 824 can have access to this information through an Application Interface (API) 819 with pre-specified and well documented access and security protocols.

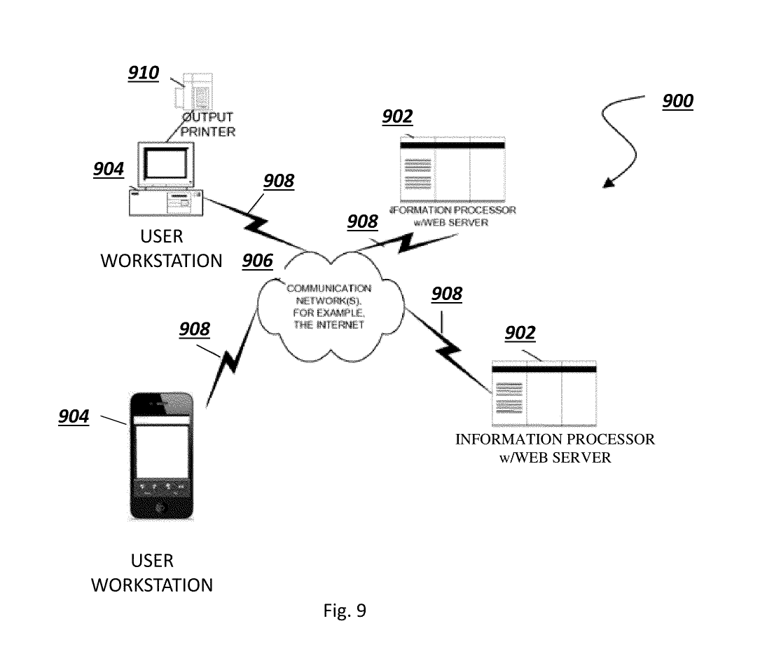

Referring to FIG. 9 a diagram is provided of an example hardware arrangement that operates for providing the systems and methods disclosed herein, and designated generally as system 900. System 900 is preferably comprised of one or more information processors 902 coupled to one or more user workstations 904 across communication network 906. User workstations may include, for example, mobile computing devices such as tablet computing devices, smartphones, wearable devices, personal digital assistants or the like. Further, printed output is provided, for example, via output printers 910.

Information processor 902 preferably includes all necessary databases for the present invention, including image files, metadata and other information. However, it is contemplated that information processor 902 can access any required databases via communication network 906 or any other communication network to which information processor 902 has access. Information processor 902 can communicate to devices as well as databases using any known communication method, including a direct serial, parallel, USB interface, or via a local or wide area network.

User workstations 904 communicate with information processors 902 using data connections 908, which are respectively coupled to communication network 106. Communication network 906 can be any communication network, but is typically the Internet or some other global computer network. Data connections 908 can be any known arrangement for accessing communication network 906, such as dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

User workstations 904 preferably have the ability to send and receive data across communication network 906, and are equipped with web browsers to display the received data on display devices incorporated therewith. By way of example, user workstation 904 may be personal computers such as Intel Pentium-class computers or Apple Macintosh computers, but are not limited to such computers. Other workstations which can communicate over a global computer network such as palmtop computers, smartphones, wearable devices (e.g., Google Glass or smart watches), personal digital assistants (PDAs) and mass-marketed Internet access devices such as WebTV can be used. In addition, the hardware arrangement of the present invention is not limited to devices that are physically wired to communication network 906. Of course, one skilled in the art will recognize that wireless devices can communicate with information processors 902 using wireless data communication connections (e.g., WIFI or BLUETOOTH) or through imbedded devices, biometric devices (e.g., bio-imbedded chips, fingerprint scans, and retina scans).

According to an embodiment of the present application, user workstation 904 provides user access to information processor 902 for the purpose of receiving and providing art-related information. The specific functionality provided by system 900, and in particular information processors 902, is described in detail below.

System 900 preferably includes software that provides functionality described in greater detail herein, and preferably resides on one or more information processors 902 and/or user workstations 904. One of the functions performed by information processor 902 is that of operating as a web server and/or a web site host. Information processors 902 typically communicate with communication network 906 across a permanent i.e., unswitched data connection 908. Permanent connectivity ensures that access to information processors 902 is always available.

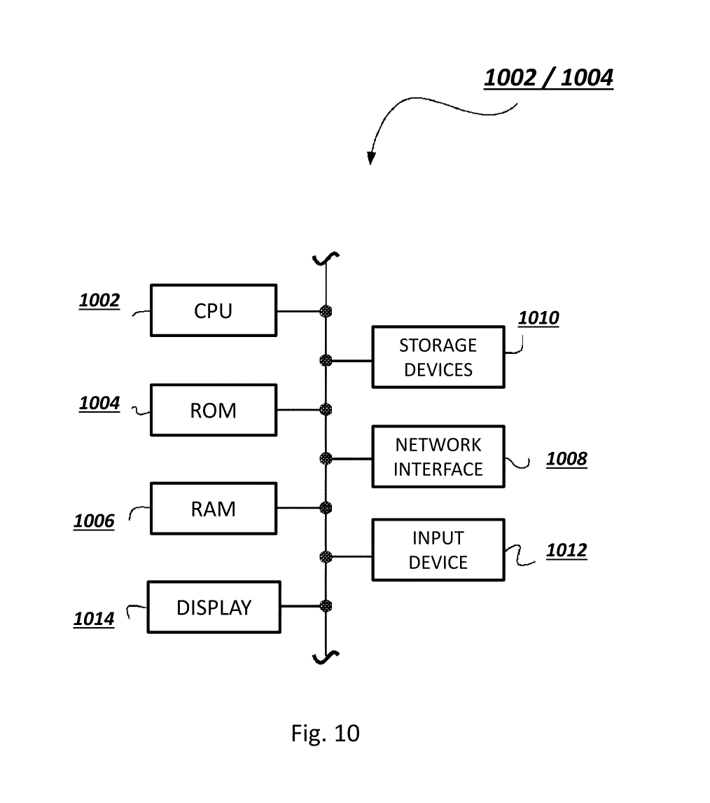

As shown in FIG. 10 the functional elements of each information processor 902 or workstation 904, and preferably include one or more central processing units (CPU) 1002 used to execute software code in order to control the operation of information processor 902, read only memory (ROM) 1004, random access memory (RAM) 1006, one or more network interfaces 1008 to transmit and receive data to and from other computing devices across a communication network, storage devices 1010 such as a hard disk drive, floppy disk drive, tape drive, CD-ROM or DVD drive for storing program code, databases and application code, one or more input devices 1012 such as a keyboard, mouse, track ball and the like, and a display 1014.

The various components of information processor 902 need not be physically contained within the same chassis or even located in a single location. For example, as explained above with respect to databases which can reside on a storage device 1010, this storage device 1010 may be located at a site which is remote from the remaining elements of information processors 902, and may even be connected to CPU 1002 across a communication network 106 via a network interface 1008.

The functional elements shown in FIG. 10 (designated by reference numbers 1002-1014) are preferably the same categories of functional elements preferably present in a user workstation 904. However, not all elements need be present, for example, storage devices in the case of PDAs, and the capacities of the various elements are arranged to accommodate expected user demand. For example, CPU 1002 in user workstation 904 may be of a smaller capacity than CPU 1002 as present in information processor 902. Similarly, it is likely that information processor 902 will include storage devices 1010 of a much higher capacity than storage devices 1010 present in work station 904. Of course, one of ordinary skill in the art will understand that the capacities of the functional elements can be adjusted as needed.

The nature of the present application is such that one skilled in the art of writing computer executed code (software) can implement the described functions using one or more or a combination of a popular computer programming language including but not limited to C++, VISUAL BASIC, PHP, JAVASCRIPT, OBJECTIVE-C, JAVA, ACTIVEX, HTML, XML, ASP, SOAP, IOS, ANDROID, TORR, SQL, ORACLE and various web application development environments.

As used herein, references to displaying data on a user workstation 904 refer to the process of communicating data to the workstation across a communication network 906 and processing the data such that the data can be viewed on the user workstation 904 display 1014 using a web browser, Graphic User Interface (GUI) or the like. The display screens on user workstation 904 present areas within control allocation system 900 such that a user can proceed from area to area within the control allocation system 900 by selecting a desired link. Therefore, each user's experience with control allocation system 900 will be based on the order with which (s)he progresses through the display screens. In other words, because the system is not completely hierarchical in its arrangement of display screens, users can proceed from area to area without the need to “backtrack” through a series of display screens. For that reason and unless stated otherwise, the following discussion is not intended to represent any sequential operation steps, but rather the discussion of the components of control allocation system 900.

Although the present application may be shown and described by way of example herein in terms of a web-based system using web browsers and a web site server (information processor 902), and with mobile computing devices (904) system 900 is not limited to that particular configuration. It is contemplated that control allocation system 900 can be arranged such that user workstation 904 can communicate with, and display data received from, information processor 902 using any known communication and display method, for example, using a non-Internet browser Windows viewer coupled with a local area network protocol such as the Internetwork Packet Exchange (IPX). It is further contemplated that any suitable operating system can be used on user workstation 904, for example, WINDOWS 3.X, WINDOWS 95, WINDOWS 98, WINDOWS 2000, WINDOWS CE, WINDOWS NT, WINDOWS XP, WINDOWS VISTA, WINDOWS 2000, WINDOWS XP, WINDOWS 7, WINDOWS 8, WINDOWS 10, MAC OS, LINUX, IOS, iPHONE, ANDROID and any suitable PDA or mobile computing device operating system.

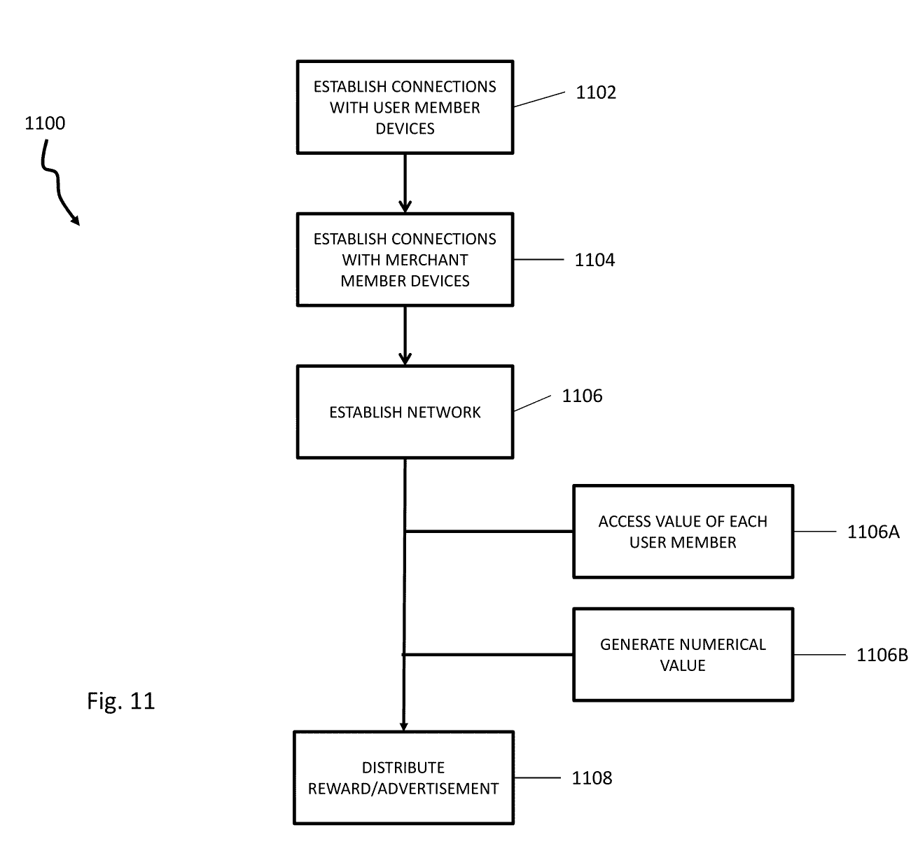

Turning now to FIG. 11, a flow diagram is described showing a routine 1100 that illustrates a broad aspect of a method in accordance with at least one embodiment disclosed herein. Several of the logical operations described herein are implemented (1) as a sequence of computer implemented acts or program modules running on computing device and/or (2) as interconnected machine logic circuits or circuit modules within one or more computing devices. The implementation is a matter of choice dependent on the requirements of the device (e.g., size, energy, consumption, performance, etc.). Accordingly, the logical operations described herein are referred to variously as operations, steps, structural devices, acts, or modules. Various of these operations, steps, structural devices, acts and modules can be implemented in software, in firmware, in special purpose digital logic, and any combination thereof. Furthermore, more or fewer operations can be performed than shown in the figures and described herein. These operations can also be performed in a different order than those described herein.

Continuing with reference to FIG. 11, as noted herein and in at least one implementation and in connection with a method of managing a plurality of devices, including to establish a user-to-user and user-to-merchant interrelated on-line network. At step S1102, the process begins and a plurality of data communication connections are established simultaneously over respective communication channels. The communication connections occur with computing devices that are respectively operated by user members, for example for reception of user member information that represents user profiles, connections with other members and locations of user members. At step S1104, a plurality of data communication connections are established over respective channels with computing devices that are respectively operated by merchant members. Merchant information can be received over the respective channels, that represents, for example, goods and/or services, promotions and store locations. Moreover, and interrelated network of user members and merchant members is established at step 1106, including by assessing a respective value of each of the user members (1106A), and by generating a respective numerical value representing each of the assessments (1106B). Thereafter, a reward and/or advertisement is distributed to each of the computing devices respectively operated by the plurality of user members (step 1108). The reward and/or advertisement is offered by each of the respective merchant members as a function of the respective generated numerical value. Thereafter, the process ends (not shown).

In addition to the features and implementations shown and described herein, various forms of functionality are provided by the present patent application. For example, a relationship between entities can be suggested, such as introducing a customer to a business. Additionally, a user or entity may be blocked from accessing the system for various reasons, such as when the user violates the terms of use of the system. An entity or user's access permissions and/or features can also be modified or adjusted in a similar fashion. In another example, an entity's scoring or weighting of one or more of its data points can be modified based on one or more factors, such as changes in the user's activity. Further, a new data point may be generated for consideration in the scoring for an entity, a particular category of entities, or all entities. Non-obvious information about an entity or category of entities classified based on a preset data point (e.g., statistics about login attempts, devices used to access the system by a given a category of users) can also be generated and/or transmitted by the system. Additionally, notifications regarding a change in an entity's profile or activity can be generated and/or transmitted by the system, for example reporting suspicious purchases of an entity to the administrator to prevent fraudulent activity in the system. In yet another example, the activities and/or profile of an entity may be automatically promoted to other entities, for instance marketing new merchant members to users in a particular geographical area.

Although one or more of the implementations described herein may be in respect to financial transactions and marketing approaches, the implementations may be applied to other types of networks where an accurate estimate of the influence, value, and spending ability of an entity in a network of entities needs to be obtained.

In view of the structure, functions, and features of the systems and methods of the network described herein, the present solution provides a dynamic, efficient, and more accurate way to compute, obtain, store, and distribute an estimate of the influence, value, and spending ability of an entity in a network of entities. Having described certain embodiments of methods and systems for setting up such a network, it will now become apparent to one of skill in the art that other embodiments incorporating the concepts of the disclosure may be used. Accordingly, the foregoing disclosure, description, and drawing figures are for illustrative purposes only.

Thus, as shown and described herein, the present application provides for linking respective devices, including as a function of bank transactions, spending activity, social networking and other captured and monitored data, such as provided by global positioning systems (GPS), geo-location, geo-fencing, and activity identifiers in accordance with a plurality of computing devices. The transaction of data can represent users account activity and provide data information to describe a form of cloud-based payment intelligence (PI). System communications, such as described herein, for respective user members can be generated and/or transmitted as a function of processed geo-location information. Moreover, transactions between a user and merchant can be completed and stored from the activities (such as response to advertising) bank transaction, location (GPS), check-in, referrals, and psychographic behaviors into a database or data cluster in a server and/or cluster of servers in a cloud-based system. Additionally, a relationship from the transaction is established or similar parent-child relationship between user and devices or bankcards. Security on the transaction may be provided with identity identification techniques [opt-in] and calculation of variances from user's geo-location, movement or activity, social graph behaviors and attitudinal patterns [i.e., likes, loyalty].

In accordance with the present application, the industry adoption of a user (a consumer) making a bankcard transaction with a mobile device does not share, track, nor store in a cloud-based system the user's payment intelligence and characterize the users spending activity behavior. The missing characteristics define the profile of a user and psychographic behavior and such as spending activity, geo-location, redeemed advertising promotions and time of day that informs a merchant what a user purchased, preferences, what advertising did he/she respond to, where did he/she shop, how much he/she spend, when and how he/she were contacted, who he/she respond to, and the attitudinal reasons why he/she like or are loyal to the merchant, all go unrecognized and unutilized. These user activities are stored and captured and described in a social graph to understand the consumer behavior to make a payment, mobile payment or bankcard transaction. Nonetheless, even with the relative convenience of the friction-free access of mobile payment methods, security still limits access to a bank transaction and its payment intelligent data. Adding in a secure method for a user opt-in approval for which data is captured and tracked safely from other users in the social network and also do not identify personal identity information. The cloud-based payment intelligence can be mined and offered to the merchant with anonymity [excludes PIT] before and post bank transaction for collecting and analyzing payment intelligence about the accounts, trends, activities and the spending behavior.

The activities of a consumer using a mobile device or bankcard are defined in whole or part by which the behavior is influenced by a merchant to make a purchase, either through an advertisement, recognizable goods or services, nearby location, preferences and loyalty (repeat customer).

In some instances, the activity can be inferred in likelihood of accuracy based on repeated behavior. For example, a consumer at a convenient store is likely to purchase milk when driving by a grocery store repeatedly on the way home from work. A consumer is likely to patronize a new restaurant influenced by an advertisement or referral from his/her social network. A consumer loyal to a merchant is likely to spend more often, including repeated purchases of products and services. A consumer searching for and finding a merchant from a mobile device is likely going to patronize the merchant location if nearby. At these locations, many types of activities may be probable for a mobile payment, but these activities do not provide meaningful payment intelligence from the consumers' location, psychographic behavior and identity characteristics mined from the social graph.

Many consumers are being influenced to make mobile payments, but the merchant does not have access to the bank transaction data to learn the behavior of the consumer. A mobile computing device or bankcard that is geo-location-aware can extract a consumers payment activity and report to the merchant what a consumer may be doing at that location, nearby or within a geo-fencing range to learn and infer what activities provide value and loyalty to repeat customers or new customers.

This disclosure is directed to, in part, facilitating payment intelligence from bank transaction accounts based on geo-location and unique psychographic behavior and identity identification characteristics. For instance, these bank transaction methods include electronic commerce transactions or any other type of money transaction. Innovations in mobile payment have simplified commerce for in-store shopping and have reduced friction perceived by the user to limit pulling out a credit card for a bank transaction payment.

The attraction of a “smart wallet” to a consumer is the simplicity of clicking or touching a button on a screen to complete a purchase. The merchant benefits from the simplicity of establishing a digital transaction relationship, thus reducing friction for paper receipts experienced at brick-and-mortar businesses and non brick-and-mortar services.

Many of the mobile computing devices, such as mobile phones, mobile tablets and mobile transport devices carried by users throughout daily interactions in the brick-and-mortar world are equipped with global positioning system (GPS) functionality to determine a geo-location of the device, and thus, a location of the corresponding user and potential consumer for nearby merchant members.

This disclosure combines the functions of a system to store data for payment intelligence (PI) hosted in a cloud-based infrastructure with the capability and function to accept a payment, mobile payment, purchase, complete a bank transaction, acceptance of payment, and storage of the transaction data. The system can store payment intelligence (PI) why the user is loyal to the merchant, product and service with brick-and-mortar stores and non brick-and-mortar services.

Business intelligence (BI) serves as a great advantage for a business if it can decipher and distill the data into meaningful information. The knowledge of how to express and use business intelligence is a differentiator for businesses to learn, react, engage and compete. In the finance industry of bank transactions made with a payment, mobile payment devices, the capability to extract the data from a mobile payment that presents information and knowledge about the transaction, user, merchant, products purchased, location (GPS), activity, social graph and attitudinal behavior offers [preference, loyalty] the competitive advantage to merchant members using data from payment intelligence (PI). The strategic composition of understanding the link between a bank transaction from payment or mobile payment activity and the psychographic behaviors of the complete cycle of a transaction with authorization of identity information [opt-in] opens up an entire new market and industry of financial intelligence not seen or readily available and unavailable with systems that are static in nature.

In an embodiment, the present application regards a system and method of capturing, targeting, mining, measuring a user's activity and linking the transaction data to calculate a score of clout and influence.

The present application provides a score for a user which is calculated from a set of activities and storage of transaction data by a method of linking accounts, account spending, account deposits, acceptance of referrals from a social network, spending of referrals, and social network activities described as invites, check-ins, reviews, and profile updates. The activities of the user are gathered from a collection of system monitored transactions on a user's mobile device, which are captured, tracked, mined, measured, and calculated to result a score of clout [influence, commissions]. The method of the score is a process to measure a user's influence with the system from a network of users in a social network and merchant members and their completion of activities to receive a commission. A high accumulation of activity is awarded points to achieve levels for a score in clout. The achieved points from the set of activities vary in weight based on a system identifying participation for a user and his/her network of users, including the actions of responding to a mobile advertising, redeeming rewards, financial accounts activity, and the activities of mobile payment and or bankcard payment with participating brick-and-mortar or online merchant members. A score for clout can rise or fall based on the number of activities and types of activities completed by the user. The security into measuring the score may be provided with identity identification techniques, approval [opt-in], social graph data, and attitudinal patterns of the user in the system [loyalty and commission]. The score of clout offers the banking industry a new way to measure consumer purchasing and spending power of a user, including his/her influence with a social network and financial ecosystem. The unique scoring method is a distinct difference measured by the financial industries FICO score that determines a users ability to pay on revolving credit and debt instruments. The score of clout can provide a means to measure the value of an active spending consumer and his/her payment intelligence for mining and analyzing.

The present application method does not provide a link between a user's activity and the measurement to calculate a score of clout for a user when triggered from a system or mobile device with a social network, financial account, advertising, merchant, retail business or service and commissions paid to user for activity.

In accordance with the present application, the measurement and scoring of a user on a system and mobile device doesn't preclude how a user is captured and tracked against a set of activities that are weighted to calculate a score which presents the user's influence with a social network, financial account, advertising, merchant, retail business or service, and commissions paid to a user. The score of clout is a measurement with a social network, merchant members and weighted set of activities. An attraction of receiving a higher clout score to a user is paid commission. To a merchant it is the ability to target more frequent and loyal customers to make a payment, mobile payment or bankcard transaction, i.e., through an advertising offer that targets a user by geo-location and geo-fencing. Until now, merchants have not had an effective way of targeting users that have a higher and repeatable spending activity from a mobile device or bankcard and convert them to loyal and lifetime customers. Existing methods do not offer a score of clout that expresses a users level of influence from a set of activities which can be measured by capturing and tracking the users mobile device within a cloud-based system, social network, mobile payment, depositing money, adding friends, referrals and referrals spending, checking in with a merchant, location data captured by GPS, including the commissions paid to the user. Users of mobile devices are becoming increasingly comfortable with sharing identity information with merchant members provided there is security to limit what data is stored from geo-locations, in-store shopping and relative shopping in a geo-fencing range. Nonetheless, even with the relative convenience of the friction-free access to mobile payment methods, security concerns still limit a users access to share a bank transaction and its payment intelligent data on a the activity. The anonymity and lack of interaction between the user and the merchant, before and post bank transaction can create potential security problems of collecting payment intelligence. The anonymity to limit the users presence from other users in the social network and social graph, including their transaction activities safeguards their personal data.

Method to store data of a users activity from mobile device or bankcard by capturing and targeting a user's activity from a series of weighted activities that trigger a system to generate a “score of clout” [influence, commissions].

Additional purpose: The score of clout defines the user's activities and links them with the payment of using a mobile device or bankcard, thus providing value creation for a merchant when the user responds to advertisement, history of purchasing goods or services, shopping by location and loyalty (repeat customer).

The calculated score is determined by the activity and transaction data stored by a method, linking accounts, account spending, account deposits, referrals, spending of referrals, and social network activities described as invites, check-ins, reviews, and profile updates.

The activity identifiers of the user are triggered from a system of transactions via geo-location, geo-fencing, identity information and segmentation of users by psychographic behavior and stored for calculation and history of the score.

A user's psychographic behavior is described when the triggers from the activities are classified and segmented into meaningful data and presented to show over time how a users behavior develops patterns and trends. The merchant benefits from knowledge of a users score of clout and become more predictive which users in the system are likely to respond to advertising and make a purchase from a bankcard or mobile device with payment capability to make a mobile payment.

The value to the user is a system to measure his/her influence among a network of users to achieve commissions for completing weighted activities, including the persistence to continue activity to achieve a higher score of clout. Frequent activity is rewarding.

The attraction to a user having a “score of clout” is merchant's ability to target a user that are more often to respond to advertising and patronize the business and make purchase. The merchant benefits from the parent-child link by establishing a digital transaction relationship.

The method provides a process to inform a merchant in the system to better target a social network of users for an advertising response and the activities of making a payment with participating brick-and-mortar or online merchant members. The merchant gains additional knowledge from payment intelligence (PI) to the expanding social network and social graph of users thus reducing friction for acquiring new and loyal consumers.

This disclosure combines the functions of a scoring system and storing of transaction data hosted in a cloud infrastructure with a collection of activities from users mobile devices for mining and analyzing a score of clout.

Capturing, targeting, measuring, mining, and calculating a user's score of clout [influence, commissions] define the real value of a user within a system. The score informs the willingness to likely have more frequent and greater spending activity, and offer higher value to a merchant. A merchant can use the payment intelligence to decipher and distill into meaningful information about users for targeting advertising and qualifying them from a social network of users that are likely to purchase the merchant members' products and services. The knowledge of how to express a score of clout is a differentiator in the social graph, which merchant members can use to learn, react, engage and compete for consumers. In the retail industry of consumer spending made from mobile phones and mobile devices, the capability to extract the data from transactions showing user activity can present valuable knowledge and patterns about the transactions, other merchant members, products purchased, location, activity of the users network to purchase, and attitudinal behavior [time, location, response, repetition] which the merchant can use to gain a competitive advantage in targeting users with greater accuracy and influence their purchasing decisions. The value creation to understanding the link between a user and his/her social graph on the basis of a score of clout, and influence, provide a more complete cycle of predictive user behavior in payment intelligence and achieving a score of clout. This opens up an entire new market and industry of measuring a user in a social network and his/her influence on the financial ecosystem not seen or offered with systems that are static in nature. The user with higher score of clout offers the financial ecosystem a value how spending power can attract merchant members.

In an embodiment the present application regards a bank transaction system and method linking accounts for prepaid account to reward interest for bonus cash account.

The present application provides a method for a user to make a bank transaction linking deposits to a closed prepaid account. The user receives additional cash, called bonus cash, as a cash reward, which can be used for spending at respective merchant members. The total amount of the cash rewarded is calculated on sliding scale based on the amount of the deposited transaction. In general terms, the users prepaid bank account operates as cash debit utility which they can spend the available deposited cash and the rewarded bonus cash with any merchant that is a member of the bonus cash program. For example, the method describes: (a) receiving transaction information associated with a deposit transaction, where the transaction includes a transaction amount and involves a deposit to a prepaid account; (b) the prepaid account has a balance; (c) the transaction amount does not exceed the limit of defined deposit described as rewarded levels for receiving bonus cash; (d) determining that the transaction is executed in accordance from a bank transaction facility and processed; and (e) the bonus cash rewards are credited to the prepaid account based at least partially on the determining that the transaction is completed. Additionally the method provides the merchant members a system: (f) receiving funds from the user of a prepaid account; (g) allowing the balance of the prepaid account to be used as a debit bank transaction on promotions offered from the merchant members. Participating merchant members can notify and target users with promotions to spend their bonus cash.

In the present application a cloud-based bank transaction can occur via linked accounts, for example, for making deposits to a closed prepaid account. The user receives additional cash as a bonus cash reward, which can be used in spending cash with participating merchant members in the bonus cash program. The user selects the funding sources, linking his/her accounts with a bank transaction and transaction information to a closed prepaid account. A user deposits an amount into the closed prepaid account and receives a bonus cash reward, which the amount is calculated on the amount of the deposit transaction and limited to the bonus cash rewarded for a limited amount deposited. The bonus cash is credited to the total sum of the balance of the prepaid closed account. A merchant gains value in participating in the bonus cash system to acquire and target users likely to spend on products and services with a pre-determined discount with their bonus cash. Additionally the merchant can target users of bonus cash with alerts and notifications making them aware of special bonus cash promotions and discounts on products. The bonus cash system builds loyal and lifetime customers and the merchant members acquire a segment of users, including those spending from prepaid accounts.

Moreover, the present application provides a bonus cash rewards system for a user the ability to deposit cash from a funding source or bank accounts and credit to his/her prepaid account a sum of bank funds to receive bonus cash rewards. The bonus cash rewards can include additional cash credited to the user's prepaid account and recognized as real cash with the balance of the deposit made by the user as a total sum of cash and bonus cash. In operation, the user spends the cash deposited to the prepaid account. When the deposited cash is spent, the bonus cash is available to spend with participating merchant members. Further, merchant members can target users with bonus cash rewards and offer promotions and advertising for products and services, which may contain discounts, or exclusivity for their loyalty or ability to spend bonus cash with the merchant members.

A user's activities in bonus cash spending alerts merchant members that are in the bonus cash rewards program. The merchant can notify the users with advertisements of goods or services, shopping locations and discounts for spending bonus cash.

The activity identifiers of the user having bonus cash are triggered from a system of transactions via geo-location, geo-fencing, identity information and segmentation of users by psychographic behavior.

A user's psychographic behavior is described when the triggers from the activities are classified and segmented into meaningful data and presented to show over time how a users behavior develops patterns and trends.

The merchant benefits from knowledge of a users activity and become more predictive which users in the system are likely to respond to advertising for bonus cash and make a purchase, such as via a mobile device smart wallet.

The attraction to a merchant is knowing what users have bonus cash available for spending and allows the merchant to target users that are more often to respond to advertising and promotions and patronize the business with a bonus cash purchase. The merchant benefits from the parent-child link by establishing a digital transaction relationship based on bonus cash spending and bonus cash spending history.

The method provides a process to inform a merchant in the system to better target a social network of users for an advertising response and the activities of users with bonus cash and making a payment with participating brick-and-mortar or online merchant members. The merchant gains additional knowledge from bonus cash payment intelligence (PI) from the expanding social network and social graph of users thus reducing friction for acquiring new and loyal consumers.

Rewarding users instant interest of bonus cash rewards to their prepaid account which they access from their mobile device smart wallet offers immediate value creation of mobile commerce to disrupt the older banking systems that offer interest checking. A merchant benefits from the system by targeting users who have bonus cash to spend on their advertising and promotions and offer a discount or exclusive deal not available to other users not participating in the bonus cash rewards system. The bonus cash system offers new innovation of passing through the cost of time to earn interest on a bank checking account and create a new incentive for merchant members to pass along the rewards of instant interest and incentivize users to spend the bonus cash on discounts and exclusive offers from their prepaid account. A merchant can use the payment intelligence of bonus cash to decipher and distill into meaningful information about users for targeting advertising and qualify them from a social network of users that are likely to purchase the merchant members products and services. The creation of instant interest for a prepaid account is a differentiator in the to merchant members who can learn, react, engage and compete for consumers. In the retail industry of consumer spending made from mobile phones and mobile devices, the capability to extract the data from transactions using bonus cash, the user activity can present valuable knowledge and patterns about the transactions, other merchant members, products purchased, location, activity of the users network to purchase, and attitudinal behavior [time, location, response, repetition] which the merchant can use to gain a competitive advantage in targeting users with greater accuracy and influence their purchasing decisions. The present application provides a method for a user to make a bank transaction, such as by linking deposits to a closed prepaid account. The user receives additional cash of instant interest (“bonus cash”) as a cash reward, which can be used for spending at merchant members.

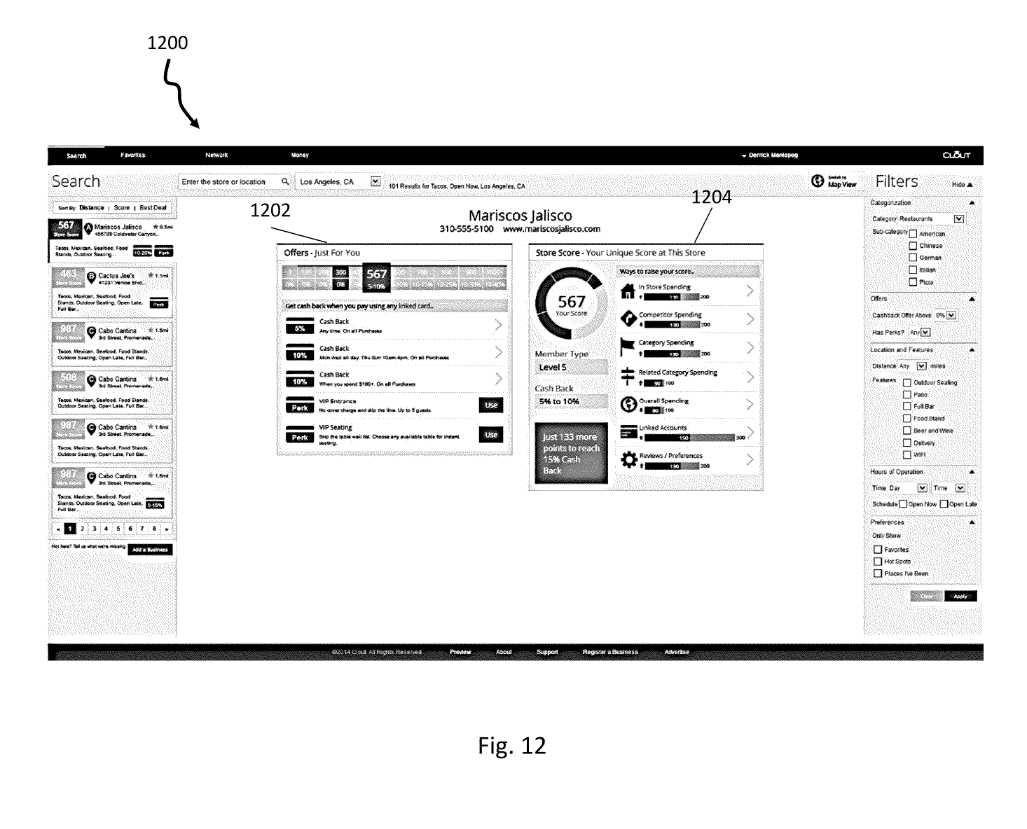

FIG. 12 illustrates an example data entry display screen 1200 identifying offers and a Store Score for a user in connection with a respective merchant. Offers section 1202, for example, identifies offers that are available at the user's current score, and includes optional cash back and VIP offers. Store score section 1204, in addition, identifies the user's Store Score, for the particular merchant, and identifies ways to raise the respective score, for example as a function of in-store spending, competitor spending, category spending or the like.

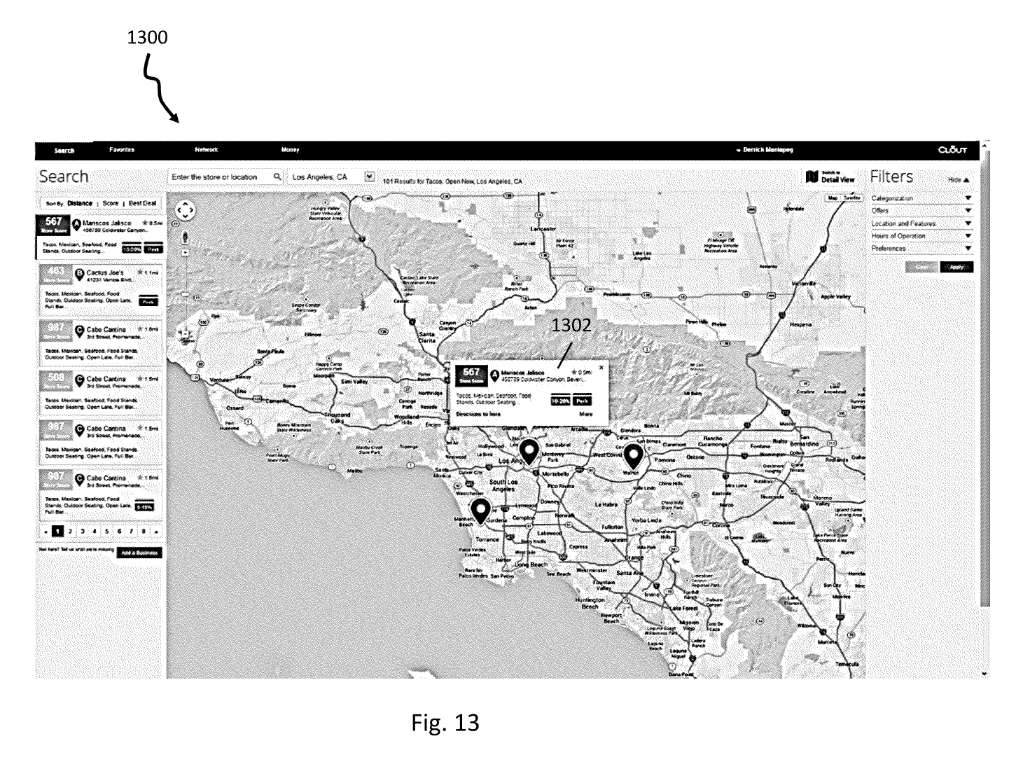

FIG. 13 is an example data entry display screen 1300 identifying an interactive map and identifying locations and directions to respective merchant stores. Additional information is illustrated in section 1302, such as the user's Store Score and options for information regarding locating a respective store and obtaining directions therefore.

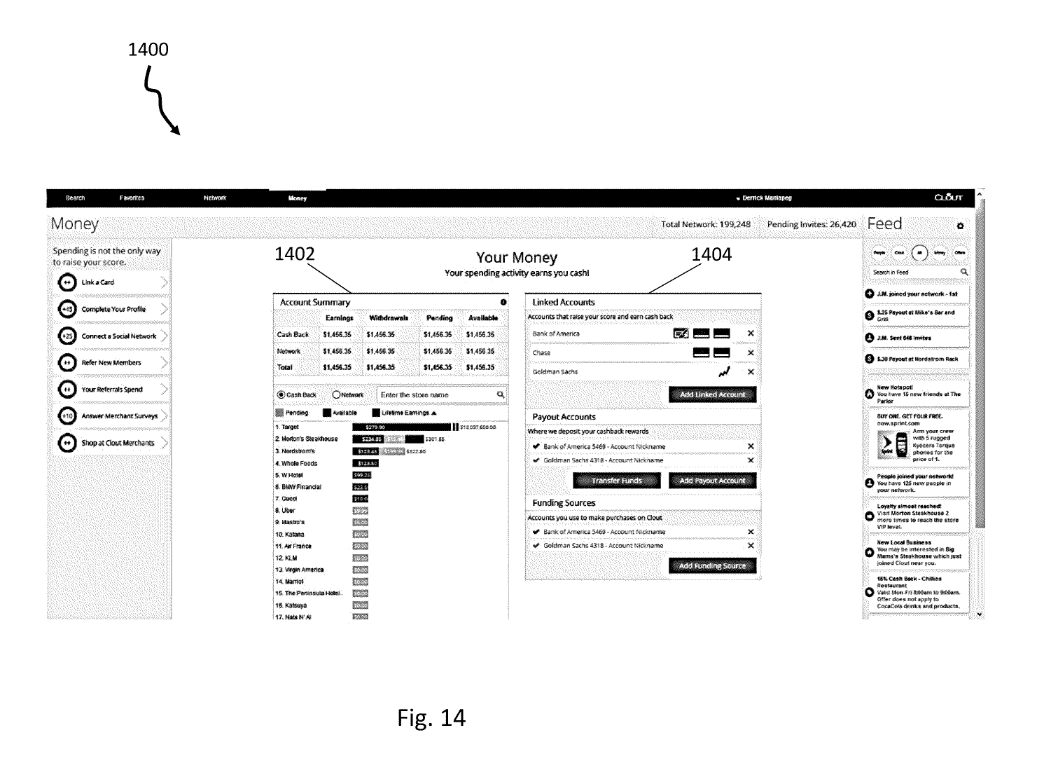

FIG. 14 illustrates an example data entry display screen 1400 identifying information associated with a respective user's money and activity. For example, account summary section 1402 shows network-based earnings and withdrawals, such as associated with cash back or the like. Summary section 1402 includes a list of merchant members and associated spending by the respective user. Also illustrated in display screen 1400 is linked account section 1404, wherein the user has linked financial accounts and options are provided for the user to transfer funds, and funding sources perform other meaningful financial activity.

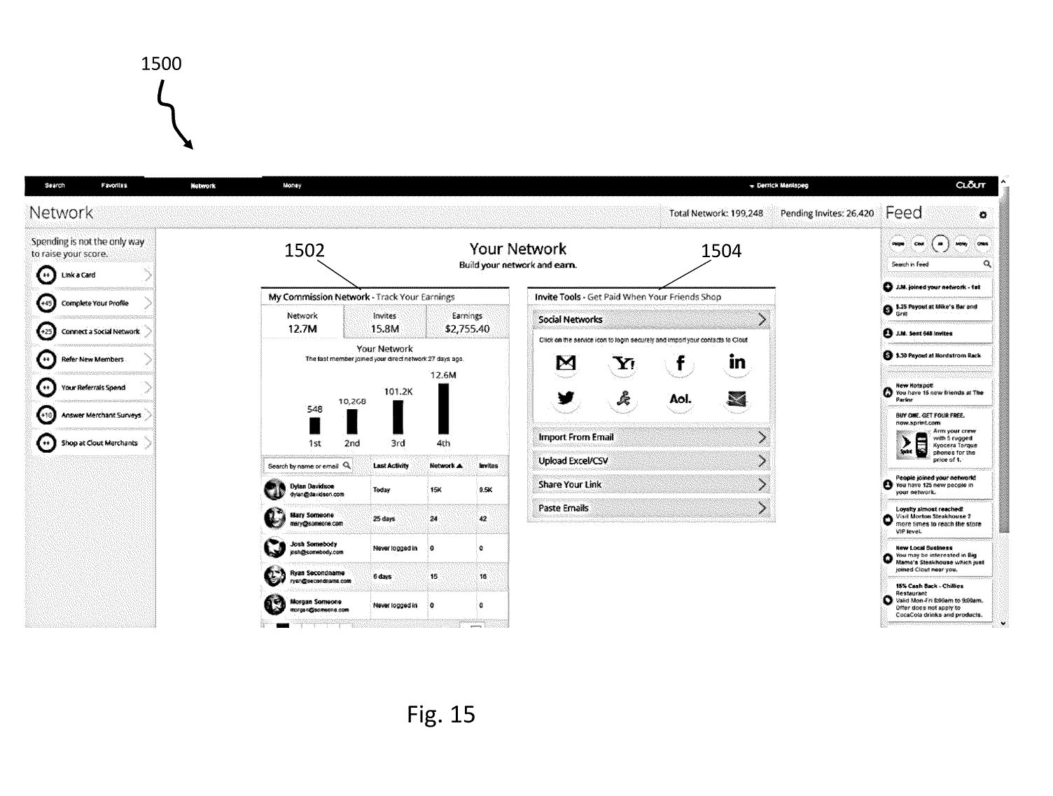

FIG. 15 illustrates an example data entry display screen 1500 that identifies an established network of user members in connection with a respective user. The display 1500 identifies earnings that can be tracked in commission section 1502 and social network information in social network section 1504. For example, in section 1502, numbers of members in the user's network are identified, as well as activity associated therewith. Social network section 1504 includes, for example, options for the user to import information, such as contact information from respective social networks.

In an embodiment, the present application relates to merchant acquisition of customers through geo-fencing optimization to target mobile smart wallet user with real-time advertisements.

The present application provides the merchant a system to optimize mobile advertisements on a network to new and existing customers using location data for a mobile device and geo-fencing optimization techniques to target a users mobile device or smart wallet. The system provides mobile ad publishing for a merchant to facilitate the acquisition of customers based on data captured from payment intelligence and spending activity with focus on optimization of geo-fencing to a segmentation of users. The merchant may analyze user activity from a data source from a dashboard heat map, query parameters from a network of user's and account activity having made a purchase, history of purchases, check-ins, deposits, and referrals, or select a group of users to publish a mobile ad in real-time to a mobile device or mobile smart wallet. The merchant can execute the mobile ad from a mobile device or online console to the users mobile device or smart wallet. Utilization of the geo-fencing data creates a real-time view into the current activity of users in a zone or region displayed in a heat map or view. The geo-fencing optimization coincides with the captured spending activity and payment intelligence from historical parameters stored in a data cluster in a server and/or cluster of servers in a cloud-based system. Mining and analyzing the real-time geo-fencing data provides the merchant better management and processes to target mobile ads. Additionally, a relationship from the geo-fencing mobile advertisement establishes a parent-child relationship between mobile devices and users. Security on the geo-fencing optimization may be provided with identity identification techniques [opt-in] and calculation of variances from user's geo-location, movement or activity, social graph behaviors and attitudinal patterns [ad response, local activity].

In accordance with the present application, the mobile ad network industry does best effort to target a mobile device or smart wallet through opt-in approvals to acquire location data from GPS and geo-fencing techniques. This is limited by the type of information captured from an active user on the network. A merchant seeking to advertise in real-time to a network of users who are potential new or existing customers is prohibitive because the information about the users spending activity and payment intelligence does not include the relationships of location, activity identifiers and payment with a mobile device or smart wallet. The history of a transaction for these activities with a merchant mobile ad is not captured and stored to learn about the users spending behavior at the time a payment is made, including any data about the intent for making a purchase from a merchant ad. A merchant that uses a mobile ad network to advertise is limited to a system by which the audience is targeted by demographics and clicking on a mobile ad, which is decremented from the total CPM [cost per thousand] ad clicks until the media buy is complete. The result is often poor because the mobile ad network doesn't work in real-time and doesn't give the merchant the capability to target its existing customers or potential new customers. Utilization of the geo-fencing data creates a real-time view into the current activity of users in an advertising zone or region. The geo-fencing optimization technique occurs at time of delivery of real-time mobile ad based on the merchant members selection of users opting in to receive a mobile ad, user pending activity and payment intelligence from historical parameters stored in a data cluster in a server and/or cluster of servers in a cloud-based system. Mining and analyzing the real-time geo-fencing data provides the merchant better ad management and processes to target mobile ads to its consumers. Additionally, a relationship from the geo-fencing mobile advertisement establishes a parent-child relationship between mobile devices and users. Security on the geo-fencing optimization may be provided with identity identification techniques [opt-in] and calculation of variances from user's geo-location, movement or activity, social graph behaviors and attitudinal patterns [ad response, local activity in the ad zone or region].

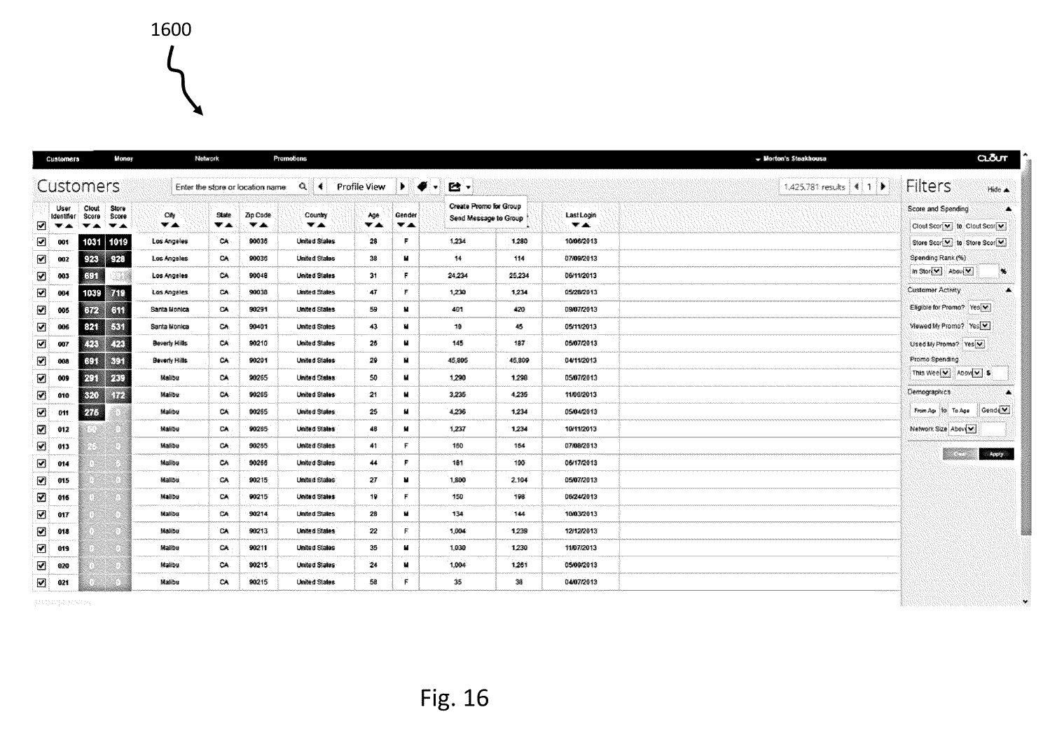

FIG. 16 is an example merchant data entry display screen 1600 that identifies a plurality of customers for a respective merchant. For example, information representing user members includes locations of the user members, age, gender login information, user identifier Clout Score and Store Score. In addition, options are provided for creating a promotion and/or message to be sent to the group of respective user members.

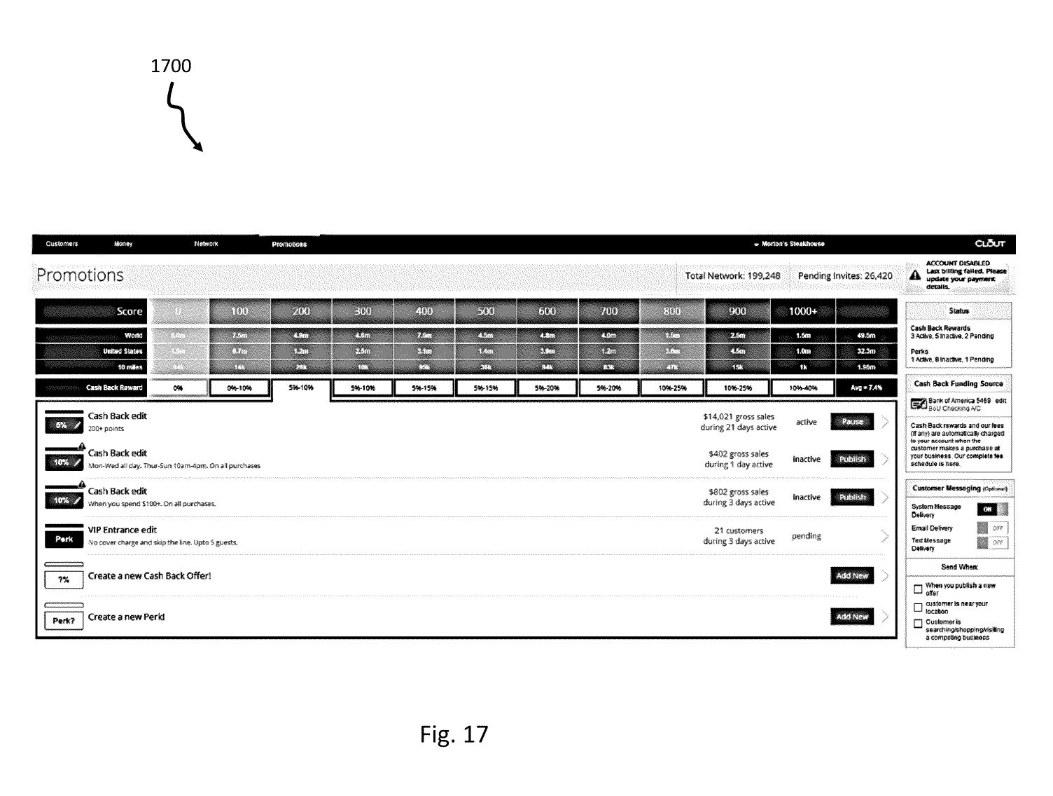

FIG. 17 is an example merchant data entry display screen 1700 that identifies promotions including cash back rewards associated with respective scores. Merchant members can use the options and display screen 1700 to define various rewards and promotions, as well as to activate and publish the rewards.

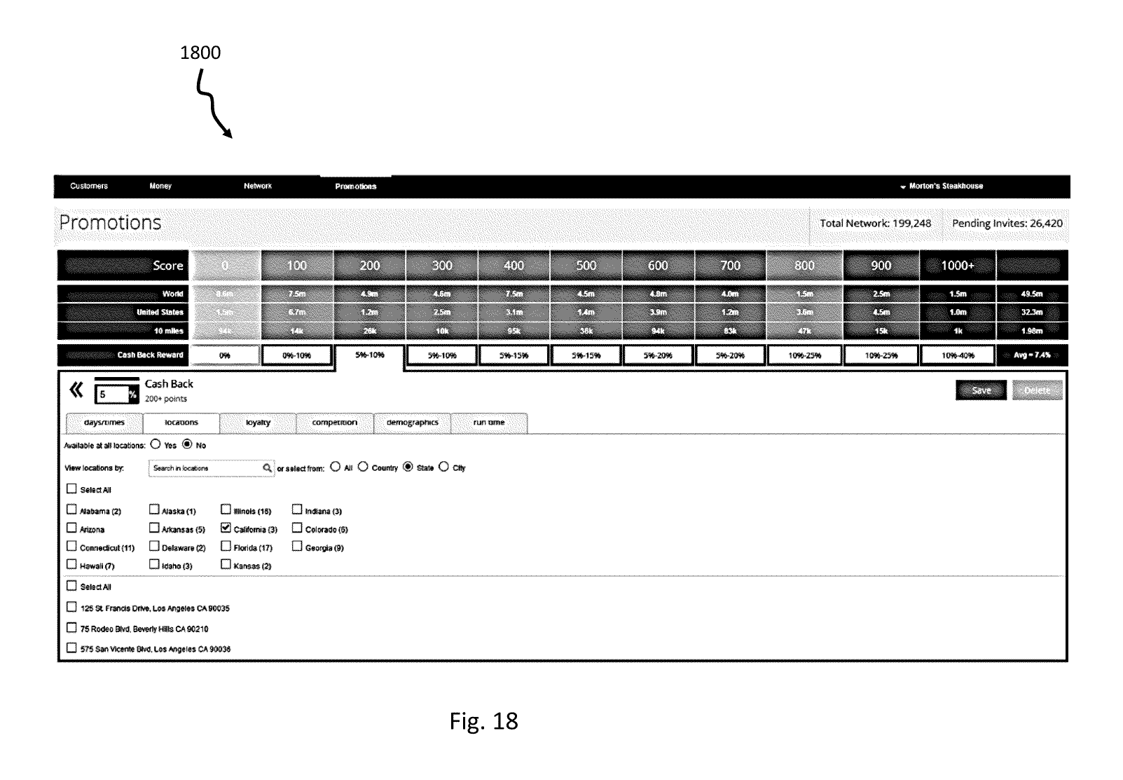

FIG. 18 is an example merchant data entry display screen 1800, which illustrates a selection of an option to edit a cash back percentage in connection with users having 200 or more points (FIG. 17). As shown in FIG. 18, options are available for a user to adjust the cash back percentage, as well as to provide details regarding days and times, locations, target competition, demographics and runtime options. In the example shown in FIG. 18, options for selecting respective states for a cash back reward are shown, with options for selecting countries, states, cities or other respective geographic information.

The present application further enables a mobile ad to be delivered to a user's mobile device or smart wallet through geo-fencing optimization in real-time from a merchant. The user with the mobile device may opt-in and release information about his/her location and activity identifiers and establish a relationship with merchant members and geo-fencing techniques for receiving mobile ads.

Additional purpose: The system provides a merchant an improved system to target its existing customers that have purchased goods and services.

A merchant can target new customers by targeting users that have purchased goods and services from similar merchant members, including the capability to target a user in a zone or region through geo-fencing optimization that combines geo-location with purchase history and spending behavior.

In some instances, the merchant can infer the geo-location of a customer based on repeated behavior. For example, a consumer at a convenient store may purchase milk and is likely to purchase milk from other convenient stores nearby in the geo-fencing region or zone. A consumer shopping at similar merchant members is likely be influenced by nearby merchant members that carry the same product or service. The capability to target a customer through geo-fencing techniques provides a level playing field to compete at person with the mobile device or smart wallet, meaning a merchant can optimize a mobile ad for time, location and immediacy rather than conventional means of static ads from print, TV, and radio.

The user cannot be identified by personal information, nor does the personal identity information [PIT] label the user by name, address, phone number or other identifiable information.

A heat map can display the zone or region of users through a mobile device or online console and identify groups or sub-groups of users who are consumers in the area.

The merchant selects the audience (groups or subgroups) to serve the mobile ad from a criterion of activity identifiers captured from spending behaviors and payment intelligence that identifies customers and its geo-fencing zone or region.

The mobile ad is served in real-time and activated by the merchant at anytime of choosing. A 3rd party media buyer can serve as the merchant account to place a mobile ad for a national brand or agency that represents a big box retailer or franchise.

Data is captured and stored on a cluster in a server or clusters in a cloud-based infrastructure. The data for a mobile ad or mobile ad campaign becomes an asset to the payment intelligence data.

This disclosure combines the functions of a system to store data for geo-fencing optimization techniques on a mobile device or smart wallet where the data is stored in a cloud-based infrastructure with the capability and function to capture, target, mine and analyze a users spending behavior and response to a real-time mobile ad from nearby merchant members. The system can store payment intelligence (PI) why the user is loyal to the merchant, product and service with brick-and-mortar stores and non brick-and-mortar services.

A merchant can target new customers by targeting mobile device and smart wallet users that have purchased goods and services from the merchant or similar merchant members, including the capability to target a customer in a zone or region through geo-fencing optimization techniques that combines geo-location with purchase history and spending behavior. The advantage of the system is the relationship of data captured from a customer that opt-in which offers a better value to merchant members. The user obtains value by receiving mobile ads that are optimized for spending behaviors and likes for a product and service. The user can at anytime turn off the geo-fencing optimization to stop future mobile ads. Personal identifiable information [PII] is not shared with the merchant; the presence of a user is unidentifiable.

In connection with FIG. 17, as a Clout merchant, every time a customer enters a store or makes a payment, the details are logged and that person's profile is instantly added to that merchant's customer database. The entire check-in and transaction history with the merchant's business is now indexed, easily accessible, and leads to his/her profile where (depending on each customer's individual privacy settings) you can see more information about each customer. Clout's analytic tools make it easy to distinguish regular customers from occasional visitors, expanders from little ones, and create customized promotions that cater to each specific customer type. Merchant members can quickly develop a large customer database simply from capturing foot traffic. Merchant members can use the program to manage campaigns and establish better relationships with their customers.

In an embodiment, the present application regards a social incentive system and gamification for earning referral cash. For example, the application includes a method to compensate a user (parent) and reward them monetarily with a commission called “referral cash” when other users in his/her multi-level referral network (children) completes and redeems a mobile advertisement from a participating merchant. The system to collect referral cash is a transaction fee coming from participating merchant members that advertise a promotion to the users on the ad network through a advertising platform. The fee is deposited to a closed account holding the referral cash and are withdrawn and paid out as commissions to deserved users meeting the criteria of completing a set of activities. This refers to the Clout Score method. Users are paid on a sliding scale of 5c-50c based on their level score in the multi-level referral network. Referral Cash is the system that deposits money into a closed account and used for paying commissions to users with achieved levels based on points. The ad transaction fee is split and distributed to the multi-level referral network. The multi-level referral network grows organically, whereas a user (sender) invites another user (responder) by e-mail, SMS, social network, in person or other methods to join the multi-level referral network.

In accordance with the present application, consumers have many options for how, where, why and when they spend their money. Advertisers have made many attempts to attract consumers with discounts and reward programs which can result in low participation when a transaction to redeem or take reward from a merchant members ad. Many of these attempts fall short of value to get new customers to purchase a product or service. The loss of repeat consumers is the development of a relationship and loyalty with the merchant. There are underling problems with all rewards programs to be friction-free and provide value. Meaning, the reward the consumer gets is often based on the purchases of that single consumer, not the network of consumers that share a common relationship with a product or service, including the consumer's relationship and influence over a network of consumers. The rewards do not take into account other activities that consumers do that ultimately help the merchant's bottom line. Some examples; sharing some private information to other consumers or network, sharing a favorite merchant or business with their friends, social network or business associates, incentivizing their network to spend, or giving feedback to a merchant. Retail merchant members and businesses have used daily deal sites like Groupon and Living Social and consumers get deep discounts at participating merchant members but rarely repeat because of incentives that keep them returning. There is no system in place to create a path of communication between the consumer and the merchant and pays a commission and reward a consumer. In addition, the merchant's net revenue is greatly reduced because it discounted the purchase, and must split the gross revenue with the co-op advertiser, daily deal publisher or third party. Some embodiments provide a system and method where a business gives rewards for the use of a credit card for purchases. In this case a qualified purchase would credit a certain number of points, miles or discount from the merchant to receive a reward for lower price or discount. This method has several limitations and doesn't create value for the consumer that would benefit from a system that pays for incentive activities that pay a commission.

The present application further supports storing data from payment or mobile payment activity via geo-location, identity information and psychographic behavior from a bank transaction linked to an account.

Further, the present application includes a method to compensate a user (parent) and reward them monetarily with a commission called “referral cash” when other users in his/her multi-level referral network (children) completes and redeems a mobile advertisement from a participating merchant. For example, referral cash can be collected and a transaction fee coming from participating merchant members that advertise a promotion to the users on the ad network through an advertising platform can be charged. The fee is deposited to a closed account holding the referral cash and are withdrawn and paid out as commissions to deserved users meeting the criteria of completing a set of social graph activities.

The ad transaction fee is split and distributed to the multi-level referral network. The multi-level referral network grows organically, whereas a user (sender) invites another user (responder) by e-mail, SMS, social network, in person or other methods to join the multi-level referral network.

The responder accepts the request by clicking the unique link sent from the sender, enters profile information, agrees to the terms of use, and confirms an email address.

The invitee is now in the inviter's down line. The inviter will earn a commission from any qualified purchase the invitee makes resulting in a referral cash fee.

This fee is distributed through a tiered method where the fee trickles down from inviter to invitee a set number of levels deep on a per transaction basis. A particular member's share of the fee is called a “referral commission.”

Consumers are inherently social and active on mobile smartphones and many social networks sharing personal information with other users and businesses. Users discuss, refer, and share their shopping experiences with their friends, associates and family. The application provides a system and method when users in a multi-level network are rewarded on completing social graph activities and are captured, measured and rewarded with commission payouts on levels achieved called “referral cash”. The referral cash network is created from enlisting users from their social network, business associates and family. The user generates income (commissions) from the merchant that pays a fee, which is deposited into the referral cash closed account and paid out to a user from their multi-level referral network of users responding to a participating merchant ad. The referral cash network collects the users profile, scoring activities and spending behavior data. The result is intelligence from a referral cash social graph that creates value for merchant members to make informed decisions for optimized targeted advertising to reach active spending and loyal consumers. Users benefit from the value of receiving ads targeted to them with certain accuracy from shared spending behaviors for products and services at merchant members every day.

Although the present invention has been described in relation to particular embodiments thereof, many other variations and modifications and other uses will become apparent to those skilled in the art. It is preferred, therefore, that the present invention not be limited by the specific disclosure herein.

What is claimed:

1. A method of managing a plurality of devices to establish a user-to-user and user-to-merchant interrelated on-line network, the method comprising:
establishing, with at least one processor, a plurality of data communication connections simultaneously over respective channels with computing devices respectively operated by user members for reception of user member information representing user profiles of user members, connections between user members, locations of user members, and/or financial transactions of user members;
establishing, with the at least one processor, a plurality of data communication connections simultaneously over respective channels with computing devices respectively operated by merchant members for reception of merchant information representing goods/services, promotions, and/or store locations;
establishing, with the at least one processor, an interrelated network of user members and merchant members as a function of the information received via the data communication connections from the user members and the merchant members, including by assessing a respective value of each of the user members to each of at least one of the respective merchant members by continually processing network activity information representing user member spending, connections among user members, and/or respective wealth of user members;
generating, with the at least one processor, a numerical value representing respective assessments of the user members in the established interrelated network; and
distributing, to each of the computing devices respectively operated by the plurality of user members, a reward and/or advertisement offered by each of the respective merchant members as a function of the respective generated numerical value.

2. The method of claim 1, wherein assessing the respective value of the user members includes managing information associated with spending activity at a merchant member's store, at a merchant member's affiliated store, at a competitor's store and/or in a particular product category.

3. The method of claim 1, further comprising:
processing, with the at least one processor, geo-location information associated with at least one of the respective merchant members and at least one of the respective user members;
determining, with the at least one processor, system communication representing a product, a recommendation, an advertisement, a service, an event, a discount, a perk, a term, and/or condition for the at least one of the respective user members as a function of the processed geo-location information; and
transmitting, with the at least one processor, to the at least one of the respective user members, the system communication.

4. The method of claim 3, further comprising:
continually monitoring, with the at least one processor, geo-location information of at least one of the user members,
determining, with the at least one processor, an updated system communication representing a product, a recommendation, an advertisement, a service, an event, a discount, a perk, a term, and/or condition for the at least one of the respective user members as a function of updated geo-location information; and
transmitting, with the at least one processor, to the at least one of the respective user members, the updated system communication.

5. The method of claim 1, further comprising:
in response to newly received network activity information associated with any one of the respective user members, updating the respective assessed value of each of the user members to each of at least one of the respective merchant members; and
generating, with the at least one processor, an updated numerical value representing respective updated assessment each of the user members in the established interrelated network.

6. The method of claim 5, wherein the newly received network activity represents at least one of a new user registration, referral information, wealth information, and a linked financial account.

7. The method of claim 1, further comprising:
providing, with the at least one processor, leads to at least one of the merchant members, wherein the leads represent a plurality of the user members targeted to receive an advertisement from the at least one of the merchant members.

8. The method of claim 7, wherein at least one lead provided to one merchant member regards a different merchant member having a previous location of the one merchant member.

9. The method of claim 1, further comprising:
assessing, with the at least one processor, a plurality of values of each of the user members; and
generating, with the at least one processor, a plurality of numerical values representing respective assessments of each user member in the established interrelated network.

10. The method of claim 1, wherein the assessed value is generated as a function of network activity at a particular time or time period.

11. A system for managing a plurality of devices to establish a user-to-user and user-to-merchant interrelated on-line network, the system comprising:
at least one processor and a computer-readable medium, wherein the at least one processor is configured to interact with the computer-readable medium in order to perform operations that include:
establishing, with at least one processor, a plurality of data communication connections simultaneously over respective channels with computing devices respectively operated by user members for reception of user member information representing user profiles of user members, connections between user members, locations of user members, and/or financial transactions of user members;
establishing, with the at least one processor, a plurality of data communication connections simultaneously over respective channels with computing devices respectively operated by merchant members for reception of merchant information representing goods/services, promotions, and/or store locations;
establishing, with the at least one processor, an interrelated network of user members and merchant members as a function of the information received via the data communication connections from the user members and the merchant members, including by assessing a respective value of each of the user members to each of at least one of the respective merchant members by continually processing network activity information representing user member spending, connections among user members, and/or respective wealth of user members;
generating, with the at least one processor, a numerical value representing respective assessments of the user members in the established interrelated network; and
distributing, to each of the computing devices respectively operated by the plurality of user members, a reward and/or advertisement offered by each of the respective merchant members as a function of the respective generated numerical value.

12. The system of claim 11, wherein assessing the respective value of the user members includes managing information associated with spending activity at a merchant member's store, at a merchant member's affiliated store, at a competitor's store and/or in a particular product category.

13. The system of claim 11, wherein the at least one processor is further configured to interact with the computer-readable medium in order to perform operations that include:
processing, with the at least one processor, geo-location information associated with at least one of the respective merchant members and at least one of the respective user members;
determining, with the at least one processor, system communication representing a product, a recommendation, an advertisement, a service, an event, a discount, a perk, a term, and/or condition for the at least one of the respective user members as a function of the processed geo-location information; and
transmitting, with the at least one processor, to the at least one of the respective user members, the system communication.

14. The system of claim 13, wherein the at least one processor is further configured to interact with the computer-readable medium in order to perform operations that include:
continually monitoring, with the at least one processor, geo-location information of at least one of the user members,
determining, with the at least one processor, an updated system communication representing a product, a recommendation, an advertisement, a service, an event, a discount, a perk, a term, and/or condition for the at least one of the respective user members as a function of updated geo-location information; and
transmitting, with the at least one processor, to the at least one of the respective user members, the updated system communication

15. The system of claim 11, wherein the at least one processor is further configured to interact with the computer-readable medium in order to perform operations that include:
in response to newly received network activity information associated with any one of the respective user members, updating the respective assessed value of each of the user members to each of at least one of the respective merchant members; and
generating, with the at least one processor, an updated numerical value representing respective updated assessment each of the user members in the established interrelated network.

16. The system of claim 15, wherein the newly received network activity represents at least one of a new user registration, referral information, wealth information, and a linked financial account.

17. The system of claim 11, wherein the at least one processor is further configured to interact with the computer-readable medium in order to perform operations that include:
providing, with the at least one processor, leads to at least one of the merchant members, wherein the leads represent a plurality of the user members targeted to receive an advertisement from the at least one of the merchant members.

18. The system of claim 17, wherein at least one lead provided to one merchant member regards a different merchant member having a previous location of the one merchant member.

19. The system of claim 11, wherein the at least one processor is further configured to interact with the computer-readable medium in order to perform operations that include:
assessing, with the at least one processor, a plurality of values of each of the user members; and
generating, with the at least one processor, a plurality of numerical values representing respective assessments of each user member in the established interrelated network.

20. The system of claim 11, wherein the assessed value is generated as a function of network activity at a particular time or time period.
